(19) United States
(12) Patent Application Publication
(10) Pub. No.: US 2004/0098306 A1
(43) Pub. Date: May 20, 2004

(54) Platform system and method for extending sales and use of a resource of motivational programs

(76) Inventors: Brian F. Fitzpatrick, Fenton, MO (US); Maddy Sheprow, Fenton, MO (US); Christine M. Ladage, St. Louis, MO (US); Dave Schulz, Chesterfield, MO (US); Fran Schuster, Chesterfield, MO (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 10/675,916

(22) Filed: Sep. 30, 2003

Related U.S. Application Data
(60) Provisional application No. 60/414,586, filed on Sep. 30, 2002.
(60) Provisional application No. 60/501,382, filed on Sep. 9, 2003.

(51) Int. Cl. G06F 17/60

(52) U.S. Cl. 705/14

(57) ABSTRACT

A system comprising a resource of programs, a platform operated by a system developer for providing access to the resource of programs, an administrative interface for use by an administrator for interfacing with the platform, a site coordinator interface for use by a site coordinator for interfacing with the platform, and a participant interface for use by participants of the particular program for interfacing with the platform.

### BACKGROUND OF THE INVENTION

The invention generally relates to systems and methods for implementing programs. In particular, the invention includes a platform system and method for extending measured performance and subjective reward and recognition and use of a resource of motivational programs.

In the past, programs such as motivational programs were provided on a stand-alone basis and were customized to fit the particular needs of the client. There is a need for a program platform and method which may be provided by a value added reseller (VAR). This allows the VAR to take advantage of programs developed by system developers and to add additional services to them. This also allows system developers to market their programs directly or through a VAR. There is also a need for such a program platform and method which allows the client to administrate or manage its programs. There is also a need for such a program which permits participant access and provides multiple methods for communicating with participants of programs.

### SUMMARY OF THE INVENTION

It is an object of this invention to permit a program system developer to provide to clients prescriptive solutions, consistently and efficiently delivered. The programs may be provided (1) by the client as a program administrator, (2) to the client directly by the developer, and/or (3) via a Value Added Reseller (VAR) to clients of the VAR. The invention allows the system developer to work closely with the program provider and/or their clients to understand the client's needs and establish programs using a pre-determined set of configurable aspects. The system and method of the invention supports the creation, configuration and tracking of all client program activity by the system developer, the VAR and/or the client. The invention also supports the inclusion of non-prescriptive (custom) configuration parameters, program data, and client-owned as well as third-party award media and award fulfillment providers.

In one embodiment, the programs of the invention are administered by designated client or system developer personnel acting in the role of a site coordinator. The systems and methods of the invention support enrolling participants, recording individual progress, calculating progress against multiple objectives, calculating awards, purchasing and issuing awards, tracking progress, and exporting data useful in the administration of a client program. Communicating information about programs with their participants is one aspect of solutions according to the invention. The systems and methods support on-line and off-line communication of program enrollments, progress-updates, and awards earned and issued to the participants. The invention also provides on-line, on-demand information about the program information, goals and rules for the participants.

In one form, the methods and systems of the invention allow external users to access functionality of the system developer site via an enterprise technology platform to sell and operate motivational programs and processes. Purchases are not online (from public domain), but through separate channel sales forces (e.g., Value-Added Resellers, independent sales reps, a sales force of the system developer) engaged in the sale of motivational programs and rewards.

In one form, the invention is a system comprising a resource of programs, a platform operated by a system developer for providing a resource of programs, an administrative interface, a site coordinator interface and a participant interface. The administrative interface is for use by an administrator for interfacing with the platform, the administrative interface for permitting the administrator to access the programs via the platform, select for the client a particular program from the accessed programs, configure the selected, particular program of the client, and track the configured program of the client. The site coordinator interface is for use by a site coordinator for interfacing with the platform, the site coordinator interface for permitting the site coordinator to access the particular program via the platform, and support the particular program of the client. The participant interface is for use by participants of the particular program for interfacing with the platform, the participant interface for permitting each participant of the particular program to access the particular program via the platform, and review information relating to the accessed, particular program.

In another form, the invention is method for use with a resource of programs comprising:

providing access to the resource of programs;

permitting an administrator to access the programs, select for the client a particular program from the accessed programs, configure the selected, particular program of the client, and track the configured program of the client;

permitting a site coordinator to access the particular program, and support the particular program of the client; and

permitting each participant of a particular program to access the particular program, and review information relating to the accessed, particular program.

In another form, the invention is a method of doing business for selling programs comprising:

providing a platform for accessing programs available via a resource);

contracting with a VAR to configure and track via the platform the programs for clients of the VAR;

authorizing a site coordinator to administer and track via the platform progress of the programs; and

permitting participants via the platform to review their program and award information.

In another form, the invention is a system for providing a platform including a resource of programs including rewards for participants of the programs. An interface permits an administrator to designate various rewards to be used with the same program and/or to designate a particular reward to be used within different programs.

In another form, the invention is a system for providing a platform including a resource of client programs including rewards for participants of the programs. An interface permits the client or its administrator to consolidate client accounts of two or more programs of the client or consolidate participant accounts of two or more programs in which the participant is enrolled.

In another form, the invention is a system for providing a platform including a resource of programs of clients including rewards for participants of the programs. An interface permits the client or its administrator to define a hierarchical group of participants and is permitted to define a rule applying to a selected group of participants wherein the hierarchical and selected groups are different.

In another form, the invention is a system for providing a platform including a resource of client programs including rewards for participants of the programs. An enrollment template includes participant information which template is downloaded from a platform of the program for population of the participant information and which template is uploaded to the program for transferring the participant information from the template to the program.

In another form, the invention is a system comprising a resource of programs, a platform operated by a system developer for providing access to the resource of programs, an administrative interface, a manager interface and a participant interface. The administrative interface is for use by an administrator for interfacing with the platform. The administrative interface permits the administrator to maintain the programs via the platform. The manager interface is for use by a site coordinator for interfacing with the platform. The site coordinator interface permits the site coordinator to access the particular program via the platform, and manage the particular program of the client. The participant interface is for use by participants and is for use by participant site administrators of the particular program for interfacing with the platform. The participant interface permits each participant of the particular program to access the particular program via the platform. The participant interface permits each participant site administrator to maintain and administer the program.

In another form, the invention is a method for use with a resource of programs comprising: providing access to the resource of programs; permitting an administrator to maintain the programs via the platform; permitting a site coordinator to access the particular program via the platform, and manage the particular program of the client; permitting each participant of the particular program to access the particular program via the platform, and permitting each participant site administrator to maintain and administer the program.

In another form, the invention is a system comprising: a resource of programs, a platform operated by a system developer for providing access to the resource of programs, and administrative interface, an operational interface and a participant interface. The administrative interface is for use by an administrator for interfacing with the platform, the administrative interface for permitting the administrator to maintain the programs via the platform. The operational interface is for use by a participant site coordinator for interfacing with the platform, the operational interface for permitting the participant site coordinator to access the particular program via the platform, and maintain and administer the particular program of the client, The participant interface is for use by participants for interfacing with the platform, the participant interface for permitting each participant of the particular program to access the particular program via the platform.

In another form, the invention is a method for use with a resource of programs comprising:

providing access to the resource of programs;

permitting an administrator to maintain the programs via the platform;

permitting each participant of the particular program to access the particular program via the platform, and permitting each participant site administrator to maintain and administer the program.

Other objects and features will be in part apparent and in part pointed out hereinafter.

### BRIEF DESCRIPTION OF THE DRAWINGS

FIG. 1 is a block diagram of one embodiment of a platform according to the invention.

FIG. 2 is a block diagram illustrating one embodiment of the functional aspects of program configuration via a VAR interface.

FIG. 2A is a block diagram illustrating the handling of the enrollment template.

FIG. 3 is a block diagram illustrating one embodiment of the functional aspects of program tracking via a VAR interface.

FIG. 4 is a block diagram illustrating one embodiment of the functional aspects of program administration via a site coordinator interface.

FIG. 5 is a block diagram illustrating one embodiment of the functional aspects of progress tracking via a site coordinator interface.

FIG. 6 is a block diagram illustrating one embodiment of the functional aspects of discretionary awards via a site coordinator interface.

FIG. 7 is a block diagram illustrating one embodiment of the functional aspects of data exporting via a site coordinator interface.

FIG. 8 is a block diagram illustrating one embodiment of the functional aspects of award calculation via a site coordinator interface.

FIG. 9 is a block diagram illustrating one embodiment of the functional aspects of order fulfillment via a site coordinator interface.

FIG. 10 is a block diagram illustrating one embodiment of the functional aspects of access to participant information via a participant interface.

FIG. 11 is a block diagram illustrating one embodiment of the platform of the invention implemented as a sales incentive manager.

FIG. 12 is a block diagram illustrating one embodiment of the platform of the invention implemented as a recognition manager.

FIGS. 13 and 14 are block diagrams of other embodiments of a platform according to the invention.

Corresponding reference characters indicate corresponding parts throughout the drawings.

### BRIEF DESCRIPTION OF THE APPENDICES

APPENDIX A is a detailed description of the method of one embodiment of the invention.

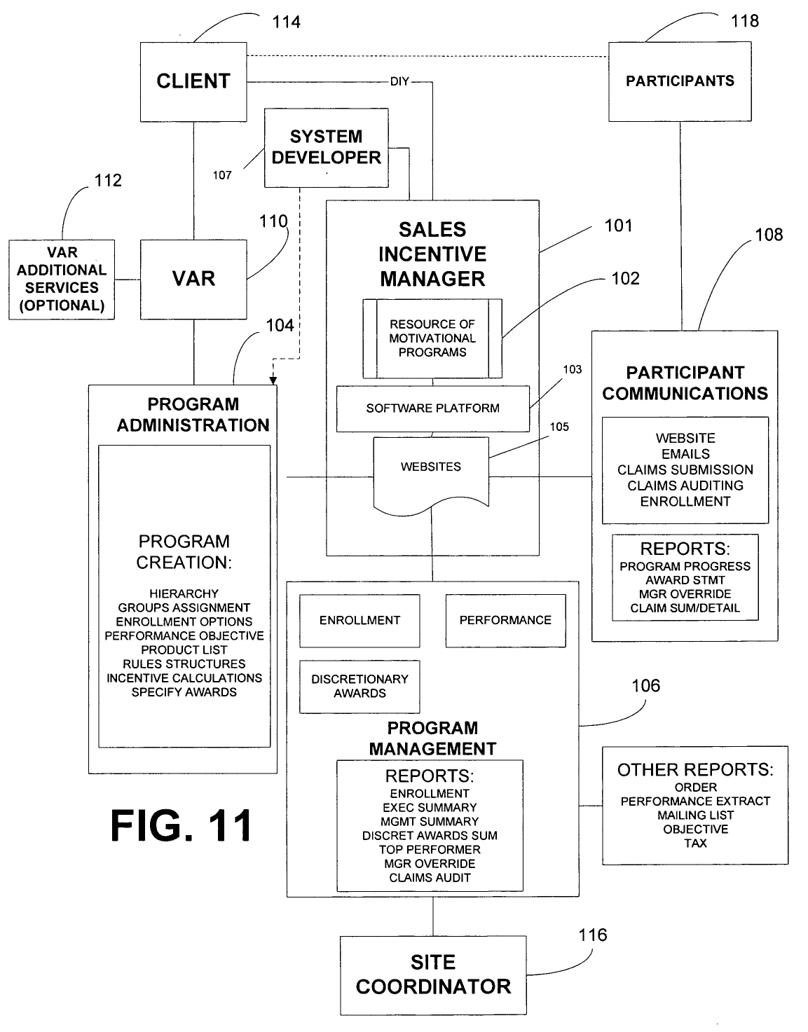

APPENDIX B-1 is features overview of the sales incentive manager platform illustrated in FIG. 11.

APPENDIX B-2 describes additional features of the sales incentive manager platform illustrated in FIG. 11.

APPENDIX B-3 describes additional awards support of the sales incentive manager platform illustrated in FIG. 11.

APPENDIX B-4 describes attribute used with respect to platform awards of the sales incentive manager platform illustrated in FIG. 11.

APPENDIX B-5 describes platform attributes of the sales incentive manager platform illustrated in FIG. 11.

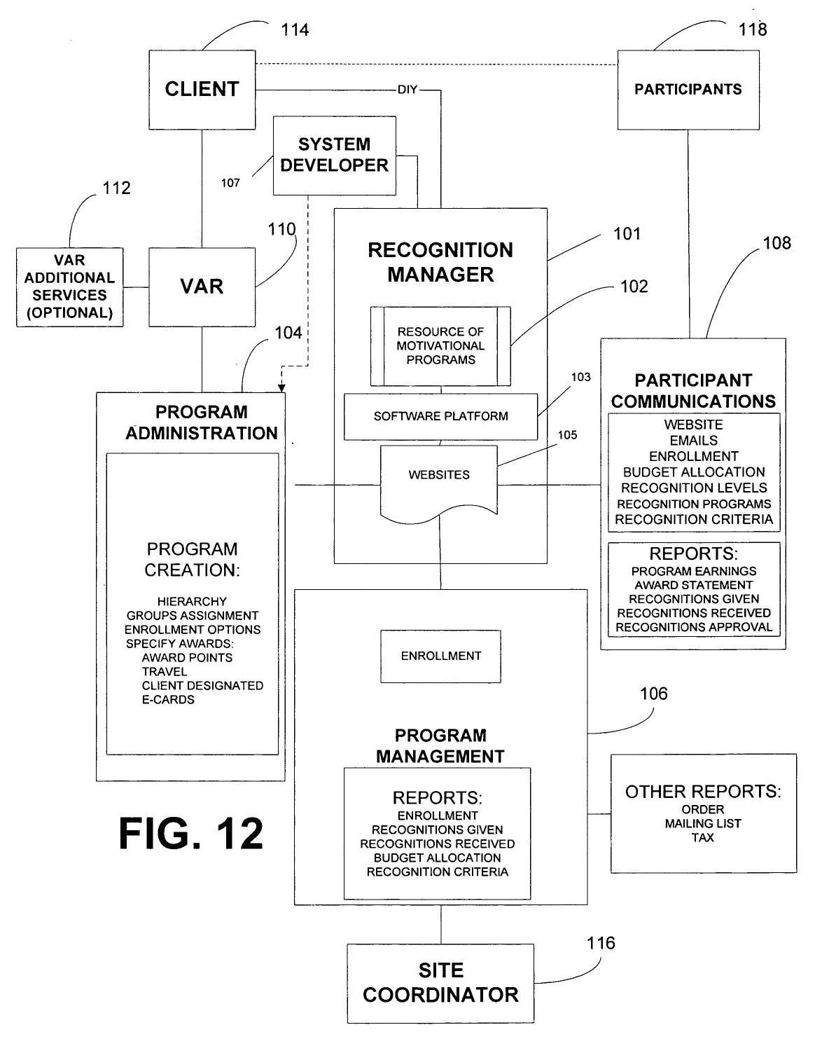

APPENDIX C is features overview of the recognition manager platform illustrated in FIG. 12.

APPENDIX D describes one embodiment of a multitier software architecture for implementing the invention.

### DETAILED DESCRIPTION OF THE INVENTION

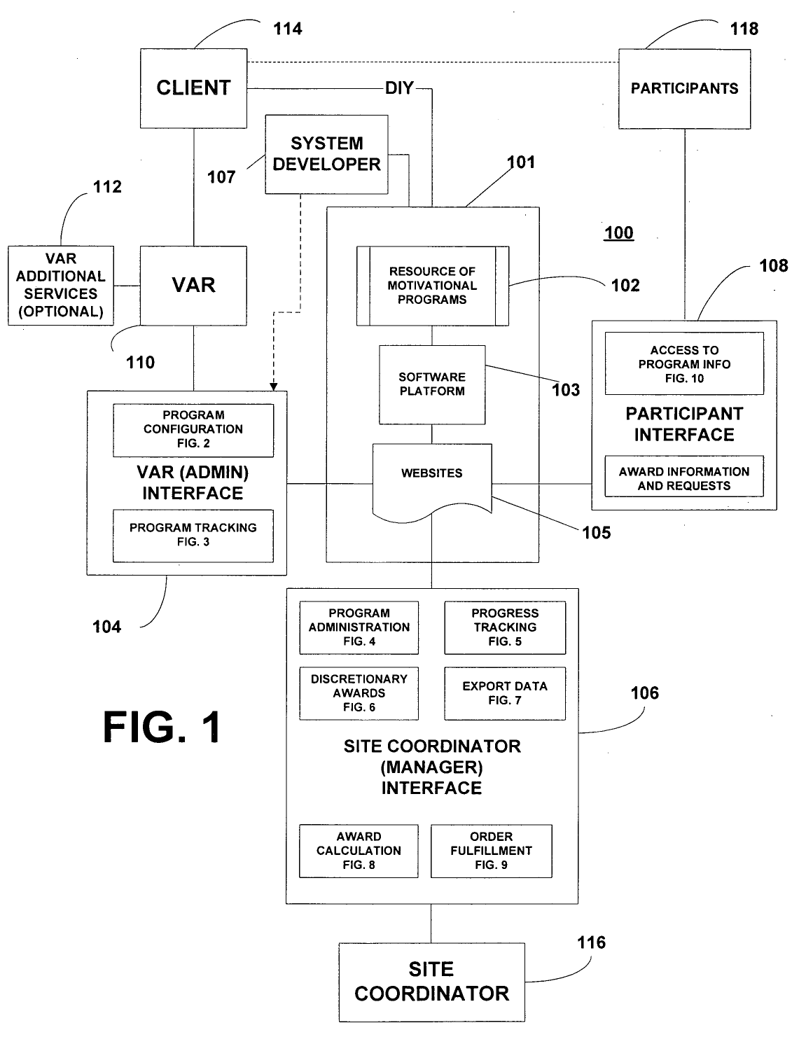

In one embodiment as illustrated in FIG. 1, a enterprise technology platform 100 is a program-based application implemented by software programs 101 including a resource 102 of motivational programs. A software platform 103 executed by one or more servers controls the operation of the enterprise technology platform 100. The platform 100 includes an administrator interface 104 (hereinafter noted as a value added reseller or VAR interface 104), a manager interface 106 (hereinafter noted as a site coordinator interface 106) and a participant interface 108. The interfaces access the resource 102 of programs via a global network, such as the Internet, or via another network, such as an intranet. The software platform 103 presents one or more websites 105 under its control to a system developer, VAR, client, site coordinator or participant accessing the platform 101.

It is contemplated that a particular client 114 may have one or more programs at any given time which involve various groups of participants 118 related to the client 114 (as indicated by the dashed line). The platform is operated by a system developer 107 which may administrate programs via the VAR interface 104 or by directly accessing, managing and/or modifying the software platform 103. A value added reseller (VAR) 110 associated with the developer 107 may be permitted access to the programs 101 on behalf of its clients. It is contemplated that the VAR 110 may offer to its clients additional services 112 in conjunction with the programs that the VAR is administering on behalf of its clients. Alternatively, a client may contract with the developer 107 to administrate its programs by directly accessing the programs 101 via a do-it-yourself (DIY) link.

Although the resource 102 is illustrated as part of the platform 100, other embodiments of the invention include the resource 102 separate from the platform 100. In addition, although FIG. 1 illustrates the resource 102 as a source of motivational programs and although the invention as described herein is illustrated as including motivational programs, it is contemplated that the resource may be a source of any type of program. In one embodiment, a motivational program may be defined as a time and/or rules-based incentive such that when a participant within a program meets a set expectation, the participant receives a reward or the ability to obtain a reward. As used herein, reward and award are used interchangeably and generally refer to any reward, award prize, recompense, payment, repayment, return, remuneration, incentive, compensation, gift, bonus or other products, services or accommodations provided to or on behalf of a participant.

In general, programs include motivational programs, incentive programs, recognition programs, suggestion programs and anniversary programs such as service anniversary programs. In one form, such programs are administered by clients 114 which have contracted with the system developer 107 (either directly, through the developer or through a VAR) to provide a motivational or incentive or other program to promote the sales of the client's products or services or to improve the performance of personnel associated with the client. Based on various criteria, such as a participant's performance, the participant receives an award and/or the ability to obtain an award. The award may be in any form and is an indication or a measurement of the participant's performance. In some forms, awards may accumulates over a period of time. For example, points which can be redeemed for merchandise and/or services are a common award. In one embodiment of the invention, as described below, points are the award. However, it is contemplated that the award may take any form so that the description below regarding points is merely exemplary and not intended to limit the scope of the claims.

In the case of awards in the form of points, when the participant decides to take advantage of the accumulated points, the participant is generally provided with a voucher or other authorization which entitles the participant to obtain products or services as a reward. Thus, as used herein, a program includes any incentive plan, award plan or policy used to encourage or reward the participant, the participant's performance, the participant's use of particular merchants which sell goods and/or services, or a combination of these. Frequently, such programs are referred to as loyalty, frequency, affinity, retention, or performance improvement programs. This is because such programs encourage or improve participant loyalty, affinity, retention, quality of performance or frequency of performance. The program permits the participants to obtain as a motivational award products and/or services.

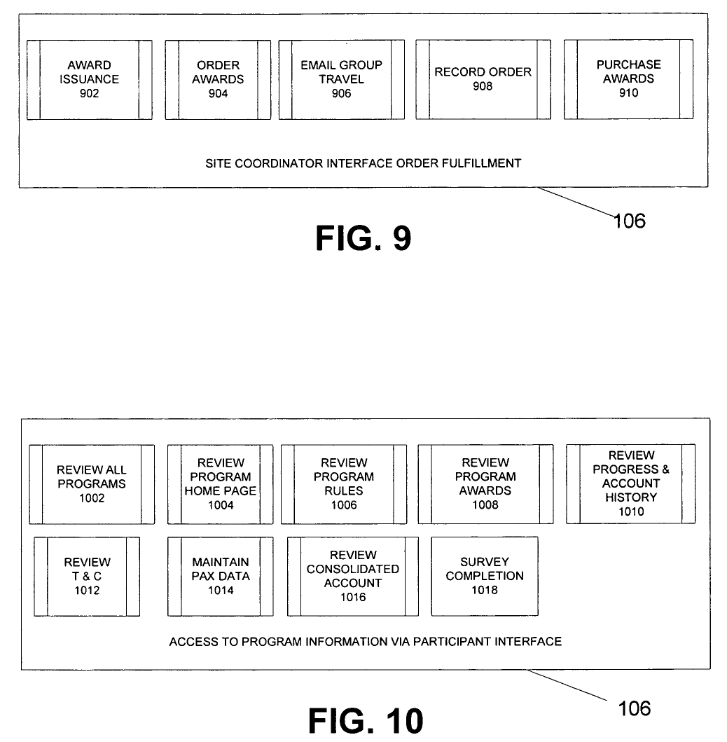

In general, the VAR interface 104 is an interface for use by any administrator such as the VAR 110 for permitting the VAR to configure and track the motivational programs of their clients. The VAR interface 104 permits the VAR to access the motivational programs of the resource 102 in order to review them and determine which program or programs would be best suited for the client or which one is desired by the client. The interface 104 also permits the VAR to select a particular motivational program for the client 114. Once a program is selected, the interface 104 permits the VAR to configure the selected program for the client, to track the configured motivational program, calculate awards of a program (see FIG. 8), and/or fulfill orders of a program (see FIG. 9)..

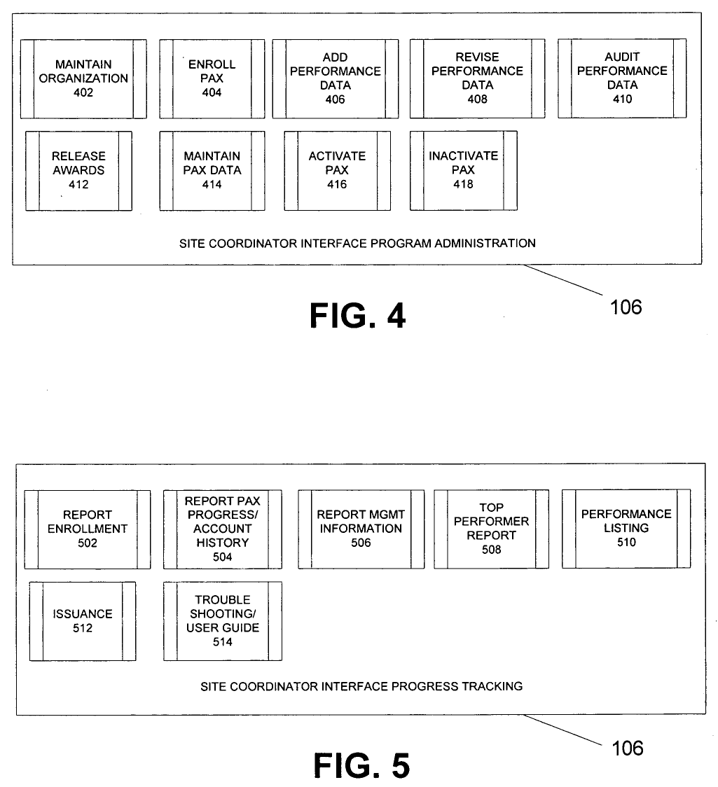

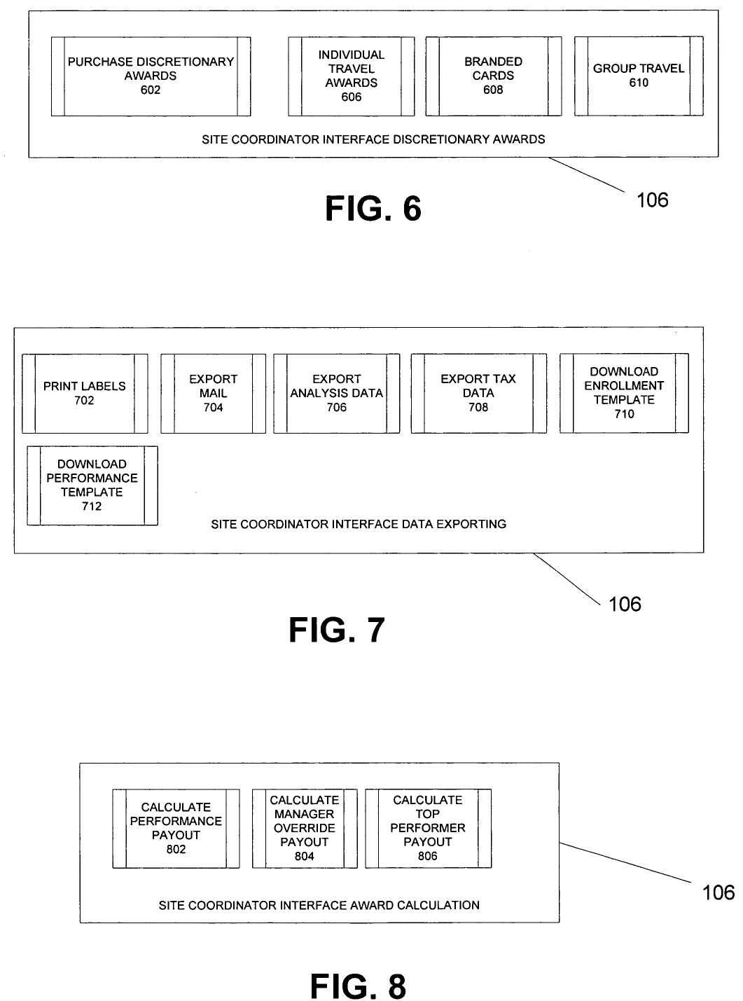

In general, the site coordinator interface 106 permits the site coordinator to perform one or more of the following with regard to program support: conduct program administration of a program (see FIG. 4), track progress of a program (see FIG. 5), manage discretionary awards of a program (see FIG. 6), export data of a program (see FIG. 7),

FIG. 1 and the above description of the various functions and who can execute the functions illustrates one embodiment of the invention. As will be noted below, some functions can be executed by more than individual whereas some functions may be designated as exclusive to a particular individual. In general, the following table illustrates some of the functions and the individuals who can execute them:

| VAR Administrator | Site Coordinator | Pax Site Administrator | Participant (pax) |
|---|---|---|---|
| Award Maintenance | Maintain Participant | Client Logo Maintenance | View Gateway |
| | Demographics | | |
| Award Group | Inquire Participant | Main Navigation | View Program |
| Maintenance | Performance | Maintenance | Homepage |
| Award Type | Inquire Participant | Pax Site Style Maintenance | View Program FAQs |
| Maintenance | Objectives | | |
| Client Maintenance | Inquire Participant | Administrator Permissions | View Program Rules |
| | Awards Issued | Maintenance | |
| Client Attribute | Submit Single | Custom Page | View/Submit Contact |
| Maintenance | Participant Enrollment | Administration | Us email |
| Client Budget | Submit Participant | Participant Content Group | View Organization; |
| Maintenance | Enrollment Batch | Maintenance | Select & View reports |
| Client Demographic | Submit Participant | Participant Report | Recognize Someone |
| Maintenance | Objectives Batch | Privilege Maintenance | |
| Implicit Group | Submit Single | Batch Participant | View Award Account |
| Maintenance | Participant | Enrollment | Statement |
| | Performance | | |
| Client Program | Submit Batch | Recognition Level | View Recognition |
| Maintenance | Participant | Maintenance | Programs |
| | Enrollments | | |
| Client Program | Search Participants | Survey Maintenance | |
| Hierarchy | | | |
| Maintenance | | | |
| Client Program | Review performance | Content Management | |
| Enrollment | submissions | Maintenance | |
| Online Enrollment | Issue Discretionary | Home Page Maintenance | |
| Configuration | Awards | | |
| Product Metric | | Rules Page Maintenance | |
| Maintenance | | | |
| Online Claim | | Award Page Maintenance | |
| Maintenance | | | |
| Program Payout Rule | | FAQ Page Maintenance | |
| Maintenance | | | |
| Program Objectives | | Contact Us Maintenance | |
| Maintenance | | | |
| Audit Participant | | Image Library Maintenance | |
| Activity | | | |
| Program Award | | Group Membership | |
| Calculations | | Maintenance | |
| Program Award | | Email (time driven) | |
| Issuance Orders | | Content Maintenance | |
| Program Report | | Email (event driven) | |
| Selection & View | | Content Maintenance | |
| Enable Participant | | Program Report Selection | |
| On-line | | & View | |
| Communications | | | |
| Enable Event-Driven | | Recognition Program | |
| email | | Maintenance | |
| Communications | | | |
| Enable Time-Driven | | | |
| email | | | |

It is also contemplated that the system may be award neutral, such as described in more detail in the appendices, particularly Appendix B-3. In this configuration, the platform 100 would be directly linked to a third party award issuer or awards could be granted by batch downloads or by approval of the VAR or a coordinator on a case by case basis. In this embodiment, awards representation would be a fractional award issuance rather than whole units only to accommodate various types of award issuance.

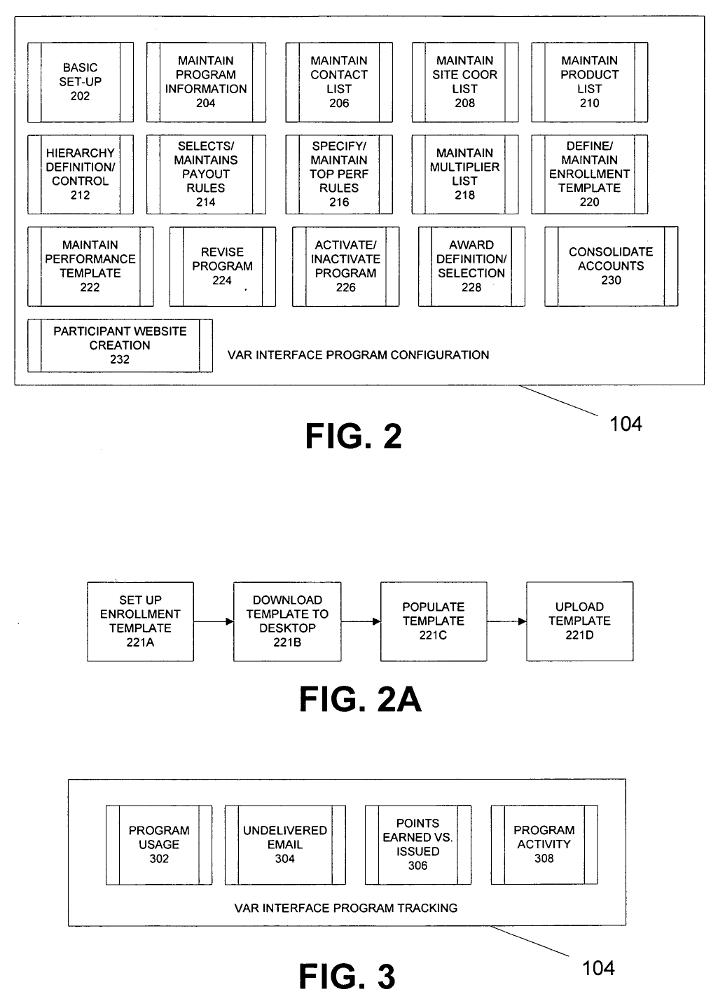

### PROGRAM CONFIGURATION BY VAR (FIG. 2)

The VAR interface 104 permits the VAR 110 to create a program for a VAR client 114 through a multi-step process of capturing and configuring many different aspects. Referring to FIG. 2, this includes basic set-up functions 202 such as assembling general information, identifying contacts relating to the program, identifying site coordinators which will have access to the program, identifying products, defining a hierarchy of participants or groups of participants, defining payout rules by which rewards are issued, defining top performer rules, defining multiplier rules and designing data entry templates.

Once a program is created, a VAR is permitted to modify the program which is referred to herein as “define”, “defining”, “revise”, “revising”, “maintain” or “maintaining”. The following functions identified as maintain or revise function are also part of the program creation or set-up.

Once a program is created, a VAR may employ the VAR interface 104 to maintain program information 204 such as review and revise the general information for the program. This may include revising the program theme, revising or defining or changing awards related to the program, revising the rules structure of the program, revising or updating a client logo. In addition, the VAR may provide additional services 112 sometimes referred to as “ala carte” services which are uniquely provided by a particular VAR.

Preferably, the VAR is aware of or can designate key contact people which relate to a particular program and employs the VAR interface 104 to maintain a contact list 206 including reviewing and revising the information needed to contact the key people. The key people may include VAR and/or client personnel that may also have other roles in the program, and may be involved in other programs as well.

As described in greater detail below, the site coordinator interface 106 allows a site coordinator 116 to coordinate or manage the program for the client 114. Preferably, it is the responsibility of the VAR via the VAR interface 104 to maintain a site coordinator list 208 by reviewing and revising a list of people that are involved in or otherwise have access to and/or control of the program for the client. This list of people may include the VAR and/or client personnel that may also have other roles in the program and may actually be involved as participants in the program as well.

Another responsibility of the VAR which can be accomplished via the VAR interface 104 is maintaining a product list 210. In general, products are any metric (e.g., sales, services, output) used to measure performance. The VAR 110 uses a VAR interface 104 to review and revise the list of client products that are used in conjunction with the payout rules for the program. The structure of product categories and items are maintained and key information is included about how to measure performance with regard to an item, and how payouts are audited.

The programs are configured by the VAR interface 104 to include a hierarchy definition and control 212. In one aspect, the hierarchy is used to define views such that only certain reports can be viewed by all participants in a particular level or in a lower level of the hierarchy structure. Also, the participants of a program may be organized according to a hierarchy. It is the responsibility of the VAR 110 via the VAR interface 104 to review and revise the organizational hierarchy of the participants in the program. In addition, the VAR may specify requirements for indicating the levels of hierarchy where volume groups and manager override options are supported and are part of the program.

Also, the participants of a program may be organized geographically so that the hierarchy is defined by location. This aspect is particularly important in international programs. For example, a motivational program may be set up for employees of a client which employees are located in a first country and a second country. The client or administrator may choose to designate the employees of each country as a separate group so that specific rules which may be country specific would apply to each group. As a further example, the employees of the first country may be provided with a stored value card of a business within the first country whereas the employees of the second country may be provided with a stored value card of a business within the second country. Furthermore, the applicable rules such as thresholds may be different.

In the process of program set up, the VAR 110 via the VAR interface 104 also selects and maintains the payout rules 214 which determine and/or control the awards being provided to the participants. In particular, the VAR would review and revise the specific payout rules that apply including specifying the discrete times when the rules apply, including specifying the products covered and including specifying how the rules structure for the program is applied. For example, all rules may indicate the specific product or discrete timeframe for which they apply. Different types of rules have different requirements for the information that must be and may be maintained. Some examples of the payout rules are as follows:

DOLLAR ONE—The amount (X) of the award earned for each amount (Y) of performance is specified. There is no objective for participants and threshold rules cannot be used. Rules applied to top performers and rules providing multipliers are optional.

HIT & WIN—The amount (X) of the award earned for meeting an objective is defined. If the objective may be different for each participant, then the objectives are maintained at the participant level when the participants are enrolled. Threshold, top performer and multiplier rules are not used.

INCREMENTAL SALES—The amount (X) of the award earned for each amount (Y) of performance over an objective is specified. If the objective may be different for each participant, then the objectives are maintained at the participant level when the participants are enrolled. Threshold rules are not used. Top performer and multiplier rules are optional.

THRESHOLDS—The amount (X) of the award earned for each amount (Y) of performance over a certain percentage (Z) of an objective is specified. If the objective may be different for each participant, then the objectives are maintained at the participant level when the participants are enrolled. Top performer and multiplier rules are optional.

UP TO & OVER—The amount (X) of the award earned for each amount (Y) of performance over 0% of an objective and the amount (X1) of the award earned for each amount (Y) of performance over 100% of the objective is specified. If the objective may be different for each participant, then the objectives are maintained at the participant level when the participants are enrolled. Top performer and multiplier rules are optional.

In the process of program configuration, the VAR 110 also employs the VAR interface 104 to specify and maintain the top performer rules 216. Specifically, the VAR reviews and revises rules for awarding top performers in the program. The system is configured such that different awards from the normal payout rules may be specified or applied to top performers. For example, the VAR may specify requirements for indicating the volume groups and levels in the hierarchy. In general, top performer rules are optional except where the rules structures are set up such that top performer rules are not allowed.

In general, the content of the groups of each hierarchical level is independent of the rules so that various rules may apply only to certain groups. In other words, the group to which a rule applies may be different that the hierarchical groups. This allows rules to be targeted to particular groups. The concept of content groups allows a dis-synchrony between hierarchy and volume groups. A content group can span 1 to n hierarchies and volume groups. Content groups are true logical groups. Hierarchical and volume groups follow a rigidly enforced vertically and horizontally defined tree structure.

The VAR also maintains a multiplier list 218 for programs which include rules for multiplying awards which are provided according to the normal payout rules within a discrete period of time. The VAR interface 104 permits the VAR 110 to review and revise the rules relating to the multiplier. This aspect is viewed as optional except where the rules structures do not allow it.

The VAR also defines and maintains enrollment templates 220 for each program. An enrollment template is used by participants 118 via the participant interface 108 to enroll in the program. The VAR interface 104 permits the VAR 110 to review and revise the make up of the data. fields in the enrollment template. The data fields may include:

Participant identification;

Hierarchy level of participant;

Reports to (e.g., participant's supervisor)

Group of participant

First Name

Middle Initial

Last Name

Mailing line(s)

Mailing city

Mailing state

Mailing zip

Mailing country

Mailing Phone

eMail Address

Company Name

Status

Login ID

Login Password

as well as any client defined attributes so configured.

As part of this aspect of the invention, the VAR 110 may indicate the level in the hierarchy and the volume group of participants and define whether participants are either on-line or off-line.

The use of the template is indicated in Appendix A at section 4, step 3, beginning at substep 4 and section 10, step 3, beginning at substep 2. In general, as shown in FIG. 2A, the handling of the template is illustrated. Initially, set up of the enrollment template 221A by the VAR includes specifying its inputs and its outputs. Preferably, this would include enrollment information (name, email address, etc.), objectives (e.g., thresholds) and performance (results attributable to each enrollee). For example, the objectives listed in the template may be:

Product Code (e.g., hours)

Cycle (e.g., quarter)

Begin (e.g., beginning date)

End (e.g.,, ending date)

Quantity (e.g., a number such as 1200)

Type (e.g., program type)

Hierarchy level

Group

Employee ID

The performance parameters listed in the template may be:

Participant ID

Date

Product Code

Quantity

Serial Number

Reference/Invoice

Notes

The template is downloaded to a desktop at 221B by anyone with authority to control enrollment, such as a VAR or site coordinator. The downloaded template on the desktop is then ready to be populated either manually or automatically. Manual population could be done by anyone with access to the desktop or with access to the template. For example, a site coordinator may email the template as an attachment to someone who would gather the information needed, add it to the template and return it to the site coordinator for uploading. Automated population may include, for example, a link to a human resources application which keeps enrollment demographic information.

Next, the populated template is uploaded at 221D either manually or automatically. Information in the template is transferred to the program for which it was created. Manual uploading could be done by anyone with access to the desktop or with access to the template. Automated uploading may include, for example, a link to a the program via one of the interfaces which is periodically executed or executed each time the template is modified and/or saved.

One of the inputs to the template (or generally an input to a program) could be related to service anniversaries. The tenure of each participant can be tracked and automated rewards can be designated by a rule of the rules engine when certain milestones (5 years or 10 years of service, etc) are accomplished. In one form, the automated awards may be an automated email describing a reward or having a reward attached. Tenure can also be used as a qualifier for other rewards.

Another aspect of program set up which the VAR interface 104 permits the VAR 110 to accomplish is maintaining performance templates 222. This includes the review and revision of the make up of data fields in the performance template that are required to record performance of participants in the program. This may include specifying the product, specifying a time frame and specifying various audit requirements. It is contemplated that the performance template may be part of the enrollment template or that it may be separate, in which case the performance template may be uploaded and downloaded as noted above with regard to the enrollment template. In other words, both templates may be combined and handled as an integrated template, particularly in certain systems. For example, an integrated template may apply in programs that are not rules based, such as “discretionary awards” programs via discretionary award products such as Reward Express offered by Maritz.

One aspect of performance which may be tracked according to the system and method of the invention includes the completion of surveys by the participants. Each participant may be requested, such as by periodic emails, to complete a survey or opinion poll which information can be used to configure or modify a program. Completion of a survey would be viewed as a performance which would quality for a reward.

In general, the VAR is also permitted to revise any existing program 224 for its particular clients. The revision may take many different forms including the revision of general information, contacts, site coordinators, products, hierarchy, payout rules, top performer rules, multiplier rules and data entry templates, as noted above. In general, no revision may have a retroactive impact to the performance or awards earned by the participants. Any aspect of the rules for the program must be made for some future time period only.

In addition, the VAR 110 via the VAR interface 104 controls the program status 226 as to whether it should the program should be activated or inactivated. To activate the program, the VAR uses the VAR interface 104 to make the program available to the site coordinators and participants. This availability may include some type of distributed communication such as an email to notify the parties involved of the status of the program. Similarly, the VAR has the authority and ability through the VAR interface 104 to block access to the program by the site coordinators and participants. This blocking may also involve some distributed communication such as email to notify the parties involved of the blocked status of the program.

In general, the administrative interface 104 permits the administrator to perform one or more of the following with regard to program configuration: setting up a program 202, maintaining information of a program 204, maintaining a contact list of a program 206, maintaining a site coordinator list of a program 208, maintaining a product list of a program 210, defining hierarchy of participants of a program 212, controlling hierarchy of participants of a program 212, selecting payout rules of a program 214, maintaining payout rules of a program 214, specifying top performer rules of a program 216, maintaining top performer rules of a program 216, maintaining a multiplier list of a program 218, maintaining an enrollment template of a program 220, maintaining a performance template of a program 222, revising a program 224, activating a program 226 and/or deactivating a program 226.

In addition, part of the program configuration by the VAR includes reward definition and selection 228. There are several aspects to this function. In general, rewards may take any form (e.g., the media may be cash, merchandise, points, stored value cards, etc.), various rewards may be used with the same program and/or the same reward may be used within different programs. Furthermore, each reward may have one or more attributes which can be associated with participants. For example, a reward may have an attribute such as size, color or logo associated with it. Such attributes can be designated for a particular participant or group of participants. Alternatively, participants can provide information, such as size, which can be used to determine the attribute of the reward to be provided to the participant. In one case, a reward may be a T-shirt and a participant may indicate their T-shirt size when enrolling. When the participant qualifies for a T-shirt, the T-shirt provided will selected to match the size of the participant receiving the T-shirt. Furthermore, each reward may have one or more attributes which can be associated with a performance parameter. For example, a first particular reward may be provided to a participant when the participant reaches a first threshold and a second particular reward (different from or related to the first reward) may be provided to the participant when the participant reaches a second threshold. Thus, this aspect of reward definition and selection 228 is related to the hierarchy definition and control 212 and the selection and maintenance of payout rules 214. Further, this aspect is related to any other functionality which may affect rewards that are issued. See APPENDICES B-4 and B-5 for a description of attributes used with respect to platform awards of the platforms illustrated in FIGS. 1-12.

It is contemplated that participant accounts and/or client accounts may be consolidated 230. For example, participants may be part of two or more programs 102 which are part of the platform 100. Optionally, the programs may be configured such that the rewards from some or all of the programs in which a particular participant participates may be designated as consolidated accounts 230. In this example, an employee of a client may be part of a sales program and a safety program, each of which issues points for certain thresholds. In this case, the client or the administrator for the client may designate that the participant be provided with a single consolidated account in which the points from both programs may be accumulated.

A client's accounts may also be consolidated so that a client could access or receive information related to the consolidated programs. For example, a client may have six programs in operation, four covering one type of employee (e.g., hourly employees) and two covering another type of employee (e.g., salaried employees). The client may opt to consolidate management and/or reporting relating to the four programs separate and apart from the other two programs. Alternatively, the client may opt for reports on each program, and consolidated reports on the four programs, the two programs and all six programs.

In another aspect of the invention, it is contemplated that participant website creation for facilitating communication with each participant would be an implicit component of instantiation of each program. For example, a VAR performing a basic set-up 202 of a program would be directed at some point during program set-up or during program definition (e.g., 204-230) to create one or more participant websites 232. Preferably, this process of creation would involve the selecting from a plurality of templates and selecting from various libraries artwork and other details to plug into the selected website template. In general, the platform 100 includes a plurality of websites 105 which may comprise three distinct web sites, one for implementing each of the administrative interface, the site coordinator interface and the participant interface and individual or group websites created with program set-up for each program participant.

Program Tracking by VAR (FIG.3)

The VAR interface 104 permits the VAR 110 to track programs which have been configured. As illustrated in FIG. 3, this tracking may include the ability of the VAR to report program usage 302. Through this function the VAR may present and permit the printing of a report of all value added aspects of the programs in the system by client and by program. As used herein, printing includes printing to screen, to paper or email. Tracking may also include the ability to provide a report of points earned vs. points issued 306. This function allows the VAR to present and permit printing of a report of all points earned as compared to all points issued through the system by the client and by the program. Tracking may also include reporting of program activity 308. This functionality allows the VAR to present and permit printing of a report of all users' activity in the system (particularly the actions on the VAR and site coordinator interfaces that may be used for client billing). Reports may be organized by client, by participant and/or by program.

In general, the administrative interface 104 permits the administrator to perform one or more of the following with regard to program tracking: track usage of a program 302, , track earned points of a program 306, track issued points of a program 306, and/or track activity of a program 308.

Site Coordinator Interface Program Administration (FIG. 4)

The system and method according to the invention as illustrated in FIG. 2 also includes a site coordinator interface 106 for permitting a site coordinator to access the platform 101. Site coordinators may include client representatives who assist in the implementation of the program for the client. As illustrated in FIG. 4, the site coordinator interface 106 allows the site coordinator 116 to maintain organization 402. The site coordinator has the functionality through the interface 106 to define and maintain the client organizations for the participants in each program according to the hierarchy configured for the program. This function also allows the site coordinator to specify requirements for volume groups and to specify manager override rules.

The site coordinator interface 106 permits the coordinator 116 to enroll participants 404. Enrollment includes creating a record of a person participating in a program through both an on-line or batch upload mechanism according to the enrollment template configured for the program. This may include people that have other roles in the program and may be involved in other programs as well. It is also contemplated that this may involve some distributed communication such as an email to notify the parties involved in the action. The interface 106 also allows the coordinator 116 to add performance data 406. As a result, a record of some performance by a person participating in a program through both an on-line and batch upload mechanism is created. This is according to the performance template configured for the program. Once a performance is recorded, the amount of the award earned is calculated according to the payout rules. Optionally, this may involve some distributed communications such as an email to notify the parties involved in the action.

Interface 106 also permits the coordinator 116 to revise performance data 408. This functionality allows the coordinator 116 to review and revise the record of some performance in a program provided that the awards earned for that performance have not yet been issued. As noted above with regard to other aspects of administration this may also involve some distributed communication such as an email to notify the parties involved in the action.

Interface 106 also permits the coordinator 116 to audit performance data 410 including the review and approval of records of performance in a program that requires approval before the earned awards are calculated. The coordinator is also able to define requirements for top performers and for manager overrides awards. Once again this audit performance data functionality may include some distributed communication.

Interface 106 also permits the coordinator 116 to release awards 412, including the review and release of awards that have been earned but not yet issued. This may initiate the purchase process in order to enable the client to pay for awards as they go, or it may automatically place orders for the awards and notify the VAR to draw down the necessary funds from an account created for the program. Distributed communication is an optional aspect of this functionality.

The ability to maintain participant data 414 is also implemented by the interface 106. The coordinator 116 is able to review and revise the record of a person participating in a program through an on-line mechanism according to the enrollment template configured for the program. This may include people that may also have other roles in the program and may be involved in other programs as well. Distributed communication is an optional aspect.

The coordinator 116 may also use the interface 106 to activate participants 416. In other words, the coordinator makes the program available to specific participants. In one embodiment this may involve some distributed communication such as email to notify the parties involved of their status in the program.

The coordinator may also inactivate participants 418. Thus, access to the program by specific participants is blocked. This may also involve some distributed communication to notify the participants involved of their status in the program.

In general, the site coordinator interface 106 permits the site coordinator 116 to perform one or more of the following with regard to program administration: maintain organization of a program 402, enroll participants of a program 404, add performance data of a program 406, revise performance data of a program 408, audit performance data of a program 410, release awards of a program 412, maintain participant data 414, activate one or more participants of a program 416, and/or inactivate one or more participants of a program 418.

Site Coordinator Interface Progress Tracking (FIG. 5)

As illustrated in FIG. 5, interface 106 also allows the coordinator to report enrollment 502. This includes presenting and allowing the printing of a report of all participants enrolled in a program by volume group and organization. The coordinator may also employ the interface 106 to report participant progress/account history 504. This includes presenting and allowing the printing of all performance records and point bank transactions for each participant in a program by volume group and organization. The coordinator may also employ the interface 106 to report management information 506, including presenting and allowing the printing of a report of all performance records for participants in a program by volume group and organization. Top performers reports 508 may also be presented or printed by volume group and organization. Performance listing reports 510 may also be presented and allowed for printing providing a report of all performance records for participants in a program by volume group and organization. Issuance reports 512 may be presented and allowed by the coordinator via the interface 506 to report all awards issued in a program by volume group, organization and by participant. Troubleshooting 514 includes presenting and allowing the printing of a user guide by rules structure, enrollment template and performance template. As noted above, any of the reports or functions herein may be with respect to two or more programs which are consolidated.

In general, the site coordinator interface 106 permits the site coordinator 116 to perform one or more of the following with regard to progress tracking: generate enrollment reports of a program 502, generate progress reports of participants of a program 504, generate account history reports of a program 504, generate management information reports of a program 506, generate top performer reports of a program 508, generate performance listings of a program 510, generate issuance reports of a program 512, generate trouble shooting reports of a program 514, and/or generate a user guide of a program 514.

Site Coordinator Interface Discretionary Awards (FIG. 6)

Interface 106 also permits the site coordinator 116 to purchase discretionary awards on behalf of the client for participants. In particular, as shown in FIG. 6, the site coordinator may present information on or allow the discretionary purchase of awards 602, individual travel awards 606, branded awards 608 and group travel awards 610, each for participants in a program of the client.

In general, the site coordinator interface 106 permits the site coordinator 116 to perform one or more of the following with regard to discretionary awards: purchase discretionary awards 602, managing individual travel awards 606, managing branded cards 608 and/or managing group travel 610.

Site Coordinator Interface Data Exporting (FIG. 7)

As shown in FIG. 7, the site coordinator 116 also employs the interface 106 to print labels 702. This includes selecting, filtering and presenting a list of participants in a program and allowing the printing of their mailing address information on standard mailing labels. The coordinator 116 may export email 704 including selecting, filtering and presenting a list of participants in a program, allowing the export of a file containing their email information to an external system for mass emailing. The coordinator also export a file containing data from a program for external analysis employing a function of export analysis data 706. Similarly, the function of export tax data 708 allows the coordinator to export a file containing data from a program for determining and reporting participant tax liability for awards issued in a program. The coordinator 116 may present and allow printing and downloading of an enrollment template 710 configured for a particular program. Similarly, the coordinator 116 may present, and allow printing and downloading of a performance enrollment template 712 configured for a program.

In general, the site coordinator interface 106 permits the site coordinator 116 to perform one or more of the following with regard to data exporting: print labels of a program 702, export mail of a program 704, export analysis data of a program 706, export tax data of a program 708, download enrollment templates of a program 710, and/or download performance templates of a program 712.

Award Calculation by Site Coordinator (FIG. 8)

Referring to FIG. 8, the site coordinator 116 employs the site coordinator interface 106 to calculate a performance payout 802. This includes the ability to calculate the amount of awards earned for the performance recorded (and audited, if necessary) according to the payout rules for a particular program. A performance record includes the amount of performance (P), the date credited (D) and the product (item) involved (I). A participant may have an objective (O) for a product/item (I) during the time from a beginning date (D1) to an ending date (D2) as necessary. Awards are calculated based on payout rules for the program.

For example, in DOLLAR ONE payout rule programs, the coordinator pays X for each Y of product/item (I) from beginning date (D1) to ending date (D2). For each record of performance for a participant, the coordinator defines the payout rule (X/Y) where

I−performance=I−payout; and

D1−payout≦D−performance≦D−payout.

For each record of performance for a participant, the coordinator also defines the multiplier rule (M) where:

D1−multiplier≦to D−performance≦D2−multiplier.

For each record of performance for a participant, the coordinator also calculates the award earned:

A−earned=P*(X/Y)*M.

As another example, for DOLLAR ONE payout rules the coordinator also calculates the total awards (TA) earned:

(TA−earned=sum A−earned) for all performance records for a participant in a program.

For DOLLAR ONE payout rules the coordinator also calculates the total awards issued:

(TA−issued=sum all awards) issued to the participant in the program (not counting discretionary awards).

Additionally, for DOLLAR ONE payout rules the coordinator calculates the award amount:

Award=TA−earned−TA−issued.

As another example, for HIT & WIN payout rules the coordinator implements paying X for achieving the objective for the products/item (I) from beginning date (D1) to ending date (D2).

As another example, for THRESHOLDS (sales, plateaus, payout rules), the coordinator pays X for each Y over the threshold T which is a percentage of an objective, for product/item (I) from beginning date (D1) to ending date (D2).

As another example, for UP & OVER payout rules, the coordinator pays X1 for each Y over 0% of an objective and pays X2 for each Y over 100% of an objective, for product/item (I) from beginning date (D1) to ending date (D2).

In general, the rules engine is configured to be capable of any algebraic calculation to implement a particular arrangement. The above merely set forth some examples.

The site coordinator 116 may also employ the site coordinator interface 106 to calculate manager override payout 804. This calculates the amount of awards earned for the manager of an organization based on the earnings of their direct reports according to the manager override rules for the particular program involved for the particular client involved. The coordinator may also calculate top performer payout 806 by selecting the participants in a program based on the top performer rules, including volume groups, levels in the hierarchy and timeframe.

In general, the site coordinator interface 106 permits the site coordinator 116 to perform one or more of the following with regard to award calculation: calculate performance payout of a program 802, calculate manager override payout of a program 804, and/or calculate top performer payout of a program 806.

Site Coordinator Interface Order Fulfillment (FIG. 9)

The site coordinator 116 employs the site coordinator interface 106 to control order fulfillment. In particular, as illustrated in FIG. 9, award issuance 902 such as the deposit of points may be automated, such as timed batch download, or may be manually controlled, such as by the site coordinator. In particular, the site coordinator may accept an order for point awards to participants in a program and deposit the points in the participants' accounts. Point awards for particular participants for many different programs are deposited in a single account. The site coordinator may also accept an order for awards fulfilled 904 to participants in a program and complete the order or place the order with a vendor. The site coordinator may also accept an order for group travel awards to participants in a program and notify the travel group via email 906 to initiate the coordination of fulfilling it. In addition, the site coordinator may record an order 908 including the recording of financial transactions for an order for any type of award to participants in a program. This may be applied to the system developers sub-ledger and record the details of the order for subsequent off-line analysis and reporting. In addition, the site coordinator may purchase awards 910. This includes presenting and the initiation of the purchase of awards to participants in a program as items in a shopping cart. This may be a multi-step process of capturing billing and shipping information, authorizing payment, and confirming the placement of the order.

In general, the site coordinator interface 106 permits the site coordinator 116 to perform one or more of the following with regard to order fulfillment: deposit points of a program 902, order items of a program 904, generate emails regarding group travel of a program 906, record orders of a program 908, and/or purchase awards of a program 910.

Participant Interface Program Information (FIG. 10)

Each participant 118 employs the participant interface 108 to obtain program information. In particular, as illustrated in FIG. 10, the participant may review all programs 1002. This includes presenting to the participant after log on and allowing the participant to select from a list of all programs for which a participant is enrolled. After selection by the participant, the participant may review the home page of the program 1004. In particular, the participant interface 108 presents a home page with general participant information to the particular participant for the selected program according to its theme and in rules structure.

The participant may also review program rules 1006. The participant interface 108 presents participant information about the rules for the participants program. It is contemplated that multiple rules may need to be presented because they may indicate a specific product or discrete timeframe for which they apply. Different types of rules have different requirements for the information that must be and/or may be presented. For example, in dollar one programs, the amount of the award earned (X) for each amount of performance (Y) is presented for hit and win programs, the amount of the award earned (X) for meeting an objective is presented. The specific objectives for the participant may also be included. For incremental sales programs, the amount of the award earned (X) for each amount of performance (Y) that is over an objective is presented. Once again the specific objectives for the particular participant may be included.

For threshold programs, the amount of the award earned (X) for each amount of performance (Y) over a certain percentage (Z) of an objective is presented. Once again, specific objectives for the particular participant may be included. For up to and over programs, the amount of the award earned (X) for each amount of performance (Y) over zero percent of an objective and the amount of the award earned (X1) for each amount of performance (Y) over one hundred percent for an objective is presented. Again, the specific objectives for the participant may be presented. For top performer programs, the amount of the award (X) for each rank (R) awarded when they are used with the program is presented. For multiplier programs, the beginning date, the ending date and the award multiplier (M) are presented when they are used with the program. For manager override rules, the basis of the override (e.g., all direct reports or earning, direct reports only) and the percentage of the average participant award to the award manager are presented, when they are used with the program, and when the participant is a qualified manager.

The participant interface 108 also allows the participant to review program awards 1008. This includes presenting participant information for the awards used in the program and links to related sites when applicable. For example, different content may be presented for different types of awards. The participant may also employ the interface 108 to review progress and account history 1010. The interface 108 presents all performance records and point bank transactions for a particular participant in a particular program. In addition, the participant may review terms and conditions (T&C) 1012 because the interface presents such terms and conditions to participants participating in a program. In addition, the participant may employ the interface 108 to maintain participant data 1014. This includes reviewing and revising the records of the participant in a program through an on-line mechanism according to the enrollment template configured for the program. This may include people that may also have other roles in the program and may be involved in other programs as well. This also may involve some distributed communication such as email to notify the parties involved of the action.

As noted above, it is contemplated that participants may be part of two or more programs 102 which are part of the platform 100. optionally, the programs may be configured such that the rewards from some or all of the programs in which a particular participant participates may be consolidated. For example, an employee of a client may be part of a sales program and a safety program, each of which issues points for certain thresholds. In this case, the client or the administrator for the client may designate that the participant be provided with a single consolidated account in which the points from both programs may be accumulated. The participant interface permits participants to review consolidated accounts 1016.

In addition, as noted above, some or all participants may be encouraged to complete an opinion poll or survey 1018 which would be viewed as a performance subject to reward. The results of the survey or poll would be available to the client, VAR, and/or site coordinator to assist in structuring the program in which the participant is involved or in structuring another program.

In general, the participant interface 108 permits each participant 118 to perform one or more of the following with regard to the access of program information: review all programs of which the participant is involved 1002, review program home pages of programs of which the participant is involved 1004, review program rules of programs of which the participant is involved 1006, review program awards of programs of which the participant is involved 1008, review the participant's progress of programs of which the participant is involved 1010, review account history of programs of which the participant is involved 1010, review terms and conditions of programs of which the participant is involved 1013, maintain participant data of the participant of programs of which the participant is involved 1014 and/or complete a survey 1018.

One Embodiment of the Method of the Invention

Appendix A illustrates the steps involved in implementing the various functions shown in FIGS. 1-12 and discussed above. In summary, these steps include the following:

Section 1 Setting up a New Program

Step 1 Setting up a Client

Step 2 Setting up a New Program

Step 3 Setting up the Hierarchy

Section 2 Defining Products

Step 1 Setting up the Product Template

Step 2 Product Setup

Section 3 Defining Awards Types

Step 1 Setting up an Award Fulfillment Group

Step 2 Setting up Program/Participant Attributes

Step 3 Associating Award Types to Programs

Section 4 Creating Rules

Step 1 Setting up the Rule Template

Step 2A Dollar One Specifics

Step 2B Hit and Win Specifics

Step 2C Top Performer Specifics

Step 2D Threshold Specifics

Step 2E Up To and Over Specifics

Step 2F Manager Override Specifics

Step 3 Objectives

Section 5 Configuring Enrollment Options

Step 1 Setting up the Enrollment Template

Step 2 Configuring Online Enrollment

Section 6 PAX site Permission and Communications

Step 1 Enabling PAX Communications/Administration

Step 2 Enabling Time and Event based emails

Section 7 Reporting

Step 1 Running a report from VAR

Step 2 Configuring reports on PAX

Section 8 PAX site Aesthetics

Step 1 Uploading Images to the Image Library

Step 2 Adding a Client Logo

Step 3 Changing Layout and Themes

Step 4 Configuring Navigation

Step 5 Setting default colors and fonts

Step 6 Setting up Links and Icons for a Recognition Manager Program

Section 9 Managing PAX site content

Step 1 Setting up Content Access using Permissions

Step 2 Configuring and Maintaining Content Rich Pages

Step 3 Configuring and Maintaining Text Pages

Step 4 Configuring Time based Email Content

Step 5 Configuring Event based Email Content

Section 10 Day to Day Operations

Step 1 Using the Site Coordinator to Obtain Information

Step 2 Batch Uploads

Step 3 Enrolling Participants

Step 4 Recording Performance

Step 5 Performing Calculations and Issuing Awards

Section 11 Setting up a Recognition Manager Program

Step 1 Setting up a Client Budget

Step 2 Setting up Recognition Levels

Step 3 Establishing Recognition Criteria

Step 4 Budget Allocation across Programs

Step 5 Setting up a Recognition Program using the Wizard

The steps of sections 1-7 are performed via the VAR interface. The steps of section 8 are performed via the participant (PAX) interface. Steps 1-5 of section 9 are performed via the PAX interface. Step 1 of section 10 is performed via the SC interface. Steps 2-4 of section 10 are performed via the PAX or SC interfaces. Step 5 of section 10 is performed via the VAR interface. Step 1 of section 11 is performed via the VAR interface. Steps 2-5 of section 11 are performed via the PAX interface.

Sales Incentive Manager

Referring to FIG. 11 and Appendix B-1, an illustration of one embodiment of the invention implemented as a sales incentive manager is illustrated.

The program administration functionality establishes and administers programs operated on the platform 100. Activities using this embodiment include identification of client, project and program details, program hierarchy, establishing the program enrollment requirements, participant objectives and products (metrics/SKUs), configuring program rules and payouts, performing calculation, acceptance and issuance of awards, enabling pax communications, online claim and online enrollment features, and administering the site administrator/pax site coordinator users. This is a webbased application accessed over the intranet, and thereby requires no installation on the “client” machine.

Appendices B-2 and B-3 describe additional features of the sales incentive manager platform illustrated in FIG. 11. In particular, appendices B-2 and B-3 describe two related embodiments of the Sales Incentive Manager which have expanded award support. The defined solutions platform of the Sales Incentive Manager as noted above is configured to support awards fulfilled via an Award Bank System (ABS). This configuration may affects profitability of the system developer by limiting the number of existing and future programs that can be supported via the Sales Incentive Manager software. Thus, awards fulfillment via other methods is also contemplated.

One embodiment which provides a solution would extend the functionality of the Sales Incentive Manager platform to provide for awards fulfillment through an unlimited number of banking or other fulfillment systems with an unlimited number of award vendors and types. Furthermore, it would allow for the use of any combination of awards within any single incentive program. This will improve the overall flexibility of platform programs, and may also increase integration with client-specific awards such as logo merchandise.

This embodiment expands Sales Incentives Manager from an ABS awards platform to a platform that is entirely award neutral. It will be possible to issue any type of award in any combination from within any particular program. This embodiment will introduce the ability to specify explicitly the data required to fulfill each award type, and to have the enrollment template automatically reflect these requirements. This is embodiment will also recognize that certain award products can be fulfilled only with information specific to the recipient, and will introduce the means to collect that information either from the program coordinators or from the award recipients themselves. In the context of the above, since award fulfillment is an asynchronous process, there are no real-time performance requirements.

Recognition Manager

Referring to FIG. 12 and Appendix C, an illustration of one embodiment of the invention implemented as a recognition manager is illustrated.

Multi-Tier Structure

APPENDIX D describes one embodiment of a multitier software architecture for implementing the invention.

Method of Doing Business

In one embodiment, the invention includes a method of doing business. For example, the business may be centered around selling motivational or other programs which are available from the platform 100. The business would include providing the platform 100 to clients 114 and administrators such as VARs 110 so that the platform is accessible and available. The clients/VARS would be permitted to access via websites 105 programs that are available via a resource 102 which could be linked to the platform or an integral part of the platform 100.

The VAR would develop its own clients. The system developer would contract with and train the VAR to configure and track via the platform programs for clients of the VAR.

A site coordinator would be authorized to administer and track, via a website 105 of the platform, the progress of the programs, as noted above. Participants associated with the clients would be involved in the program. Participants would review their program and award information via a website 105 of the platform.

In one embodiment, the VAR is responsible for payment to the system developer for programs of their clients. In one embodiment, the system developer pays commissions on the sale or distribution of program awards through the VAR's programs. In one embodiment, the VAR is permitted to add additional services 112 to the programs.

Other Embodiments

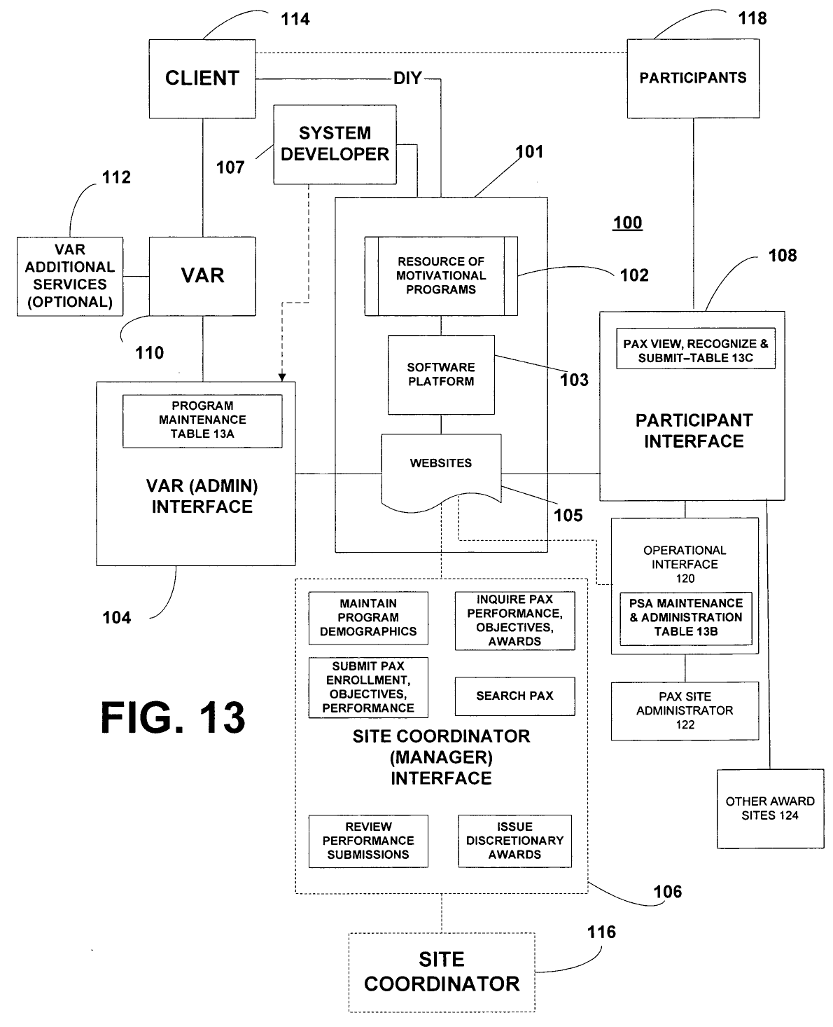

In general, as noted above in some respects, each of the functions performed by a particular administrator or coordinator can also be designated for performance by another. For example, FIG. 13 illustrates an embodiment of the platform 100 of the invention wherein the functions that can be performed by an administrator or coordinator are different than as illustrated in FIGS. 1-12. A pax site administrator 122 has been added and is provided access to the platform via an operational interface 120. Operational interface 120 may be directly connected to via websites 105 to the software programs 101 or the operational interface 120 may be connected to or be an integral part of the participant interface 108. In addition, the participant interface 108 may be linked to other award sites 124 which could provide awards to participants 118.

As illustrated in FIG. 13, the VAR administrator is primarily responsible for program maintenance which would include one or more of the functions noted in Table 13A.

TABLE 13A

| Corresponding | |
|---|---|
| References | VAR Administrator 110 |
| 228 | Award Maintenance |
| 228 | Award Group Maintenance |
| 228 | Award Type Maintenance |
| 202 | Client Maintenance |
| 202 | Client Attribute Maintenance |
| New | Client Budget Maintenance |
| 202 | Client Demographic Maintenance |
| New | Implicit Group Maintenance |
| 204 | Client Program Maintenance |
| 212 | Client Program Hierarchy |
| | Maintenance |
| 220 | Client Program Enrollment |
| 220 | Online Enrollment Configuration |
| 210 | Product Metric Maintenance |
| New | Online Claim Maintenance |
| 214 | Program Payout Rule Maintenance |
| 222 | Program Objectives Maintenance |
| 302 | Audit Participant Activity |
| 802-806 | Program Award Calculations |
| 512, 902-10 | Program Award Issuance Orders |
| 502-514 | Program Report Selection & View |
| 232 | Enable Participant On-line |
| | Communications |
| New | Enable Event-Driven email |
| | Communications |
| New | Enable Time-Driven email |
| | Communications |

The column on the left of Table 13A indicates the corresponding reference characters of functions identified about with regard to FIGS. 1-12. The functions noted as “new”in the left column have been added to the embodiment of FIG. 13 and do not have a corresponding reference character in FIGS. 1-12.

As illustrated in FIG. 13, the pax site administrator is primarily responsible for program maintenance and administration which would include one or more of the functions noted in Table 13B.

TABLE 13B

| Reference | |
|---|---|
| Corresponding | Pax Site Administrator |
| New | Client Logo Maintenance |
| New | Main Navigation Maintenance |
| New | Pax Site Style Maintenance |
| New | Administrator Permissions |
| | Maintenance |
| New | Custom Page Administration |
| New | Participant Content Group |
| | Maintenance |
| New | Participant Report Privilege |
| | Maintenance |
| New | Batch Participant Enrollment |
| New | Recognition Level Maintenance |
| New | Survey Maintenance |
| New | Content Management Maintenance |
| New | Home Page Maintenance |
| New | Rules Page Maintenance |
| New | Award Page Maintenance |
| New | FAQ Page Maintenance |
| New | Contact Us Maintenance |
| New | Image Library Maintenance |
| New | Group Membership Maintenance |
| New | Email (time driven) Content |
| | Maintenance |
| New | Email (event driven) Content |
| | Maintenance |
| 502-514 | Program Report Selection & View |
| New | Recognition Program Maintenance |
| 410 | Approve/Audit Performance Claim |

The column on the left of Table 13B indicates the corresponding reference characters of functions identified about with regard to FIGS. 1-12. The functions noted as “new” in the left column have been added to the embodiment of FIG. 13 and do not have a corresponding reference character in FIGS. 1-12.

As illustrated in FIG. 13, the participant is primarily responsible for using the program to view, recognize and submit information which would include one or more of the functions noted in Table 13C.

TABLE 13C

| Corresponding | |
|---|---|
| References | Participant (pax) |
| 1002 | View Gateway |
| 1004 | View Program Homepage |
| 1012 | View Program FAQs |
| 1006 | View Program Rules |
| New | View/Submit Contact Us email |
| New, 1010 | View Organization; Select & View reports |
| New | Recognize Someone |
| 1010 | View Award Account Statement |
| New, 1002 | View Recognition Programs |
| New | Submit performance claim |

The column on the left of Table 13C indicates the corresponding reference characters of functions identified about with regard to FIGS. 1-12. The functions noted as “new” in the left column have been added or expanded to the embodiment of FIG. 13 and do not have a corresponding reference character in FIGS. 1-12.

As illustrated in FIG. 13, the site coordinator is primarily responsible for program management which would include one or more of the following functions noted in TABLE 13D

TABLE 13D

| Corresponding | |
|---|---|
| References | Site Coordinator |
| 414 | Maintain Participant |
| | Demographics |
| 504 | Inquire Participant |
| | Performance |
| 504, 506 | Inquire Participant Objectives |
| 504, 512 | Inquire Participant Awards |
| | Issued |
| 404, 414 | Submit Single Participant |
| | Enrollment |
| New | Submit Participant Objectives |
| | Batch |
| 712, 406 | Submit Single Participant |
| | Performance |
| 414 | Submit Batch Participant |
| | Enrollments |
| 414 | Search Participants |
| 410 | Review performance |
| | submissions |
| 910, 904, 902 | Issue Discretionary Awards |

The column on the left of Table 13D indicates the corresponding reference characters of functions identified about with regard to FIGS. 1-12. The function noted as “new” in the left column has been added to the embodiment of FIG. 13 and does not have a corresponding reference character in FIGS. 1-12.

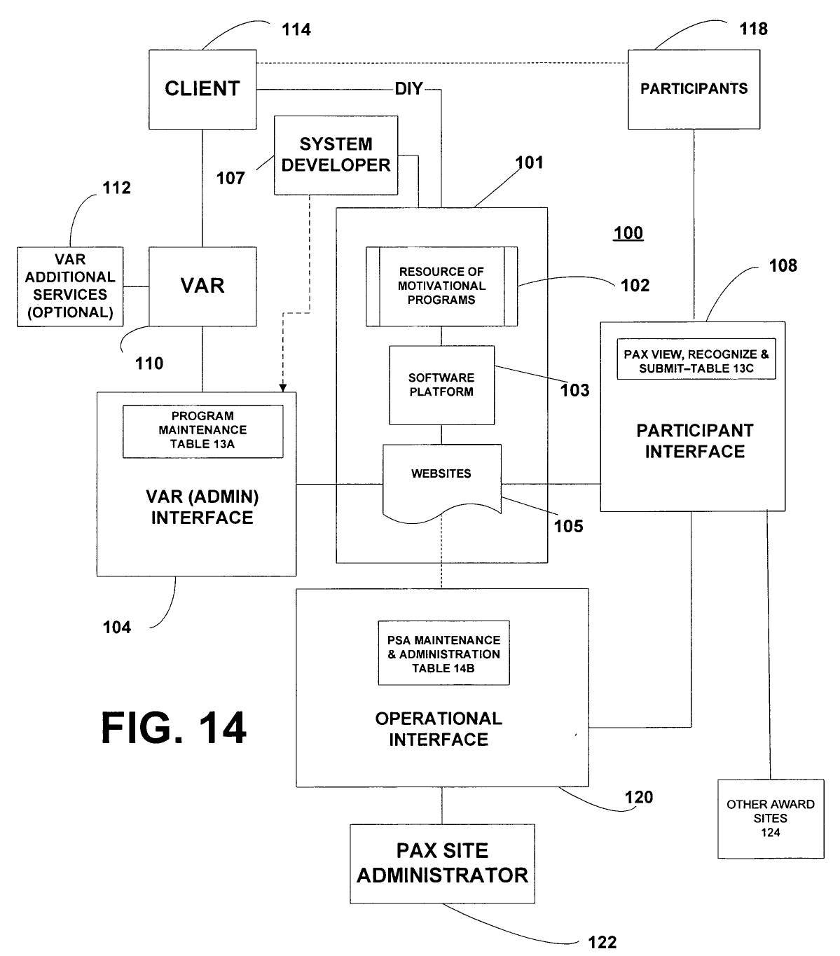

As another example, FIG. 14 illustrates an embodiment of the platform 100 of the invention wherein the functions that can be performed by an administrator or coordinator are different than as illustrated in FIGS. 1-13.

As illustrated in FIG. 14, the VAR administrator 110 is primarily responsible for program maintenance which would include one or more of the functions noted in Table 13A. The pax site administrator 122 is primarily responsible for maintenance and administration as illustrated in the following Table 14B.

TABLE 14B

| Corresponding | |
|---|---|
| References | Pax Site Administrator |
| New | Client Logo Maintenance |
| New | Main Navigation Maintenance |
| New | Pax Site Style Maintenance |
| New | Administrator Permissions Maintenance |
| New | Custom Page Administration |
| New | Participant Content Group Maintenance |
| New | Participant Report Privilege Maintenance |
| 410 | Review performance submissions |
| New | Recognition Level Maintenance |
| New | Survey Maintenance |
| New | Content Management Maintenance |
| New | Home Page Maintenance |
| New | Rules Page Maintenance |
| New | Award Page Maintenance |
| New | FAQ Page Maintenance |
| New | Contact Us Page Maintenance |
| New | Image Library Maintenance |
| New | Group Membership Maintenance |
| New | Email (time driven) Content Maintenance |
| New | Email (event driven) Content Maintenance |
| 502-514 | Program Report Selection & View |
| New | Recognition Program Maintenance |
| 410 | Approve/Audit Performance Claim |
| 414 | Maintain Participant Demographics |
| 504 | Inquire Participant Performance |
| 504, 506 | Inquire Participant Objectives |
| 504, 512 | Inquire Participant Awards Issued |
| 404, 414 | Submit Single Participant Enrollment |
| 404, 414 | Submit Participant Enrollment Batch |
| New | Submit Participant Objectives Batch |
| 712, 406 | Submit Single Participant Performance |
| 414 | Search Participants |
| 902, 910, 904 | Issue Discretionary Awards |
| 410, 504 | Audit Participant Activity |

The column on the left of Table 14B indicates the corresponding reference characters of functions identified about with regard to FIGS. 1-13. The functions noted as “new” in the left column have been added to the embodiment of FIG. 13 and do not have a corresponding reference character in FIGS. 1-12.

The participant 118 is primarily responsible for using the program to view, recognize and submit information which would include one or more of the functions noted in Table 13C.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

### APPENDIX A—ONE EMBODIMENT OF METHOD OF INVENTION

Section 1 Setting up a New Program

The Platform is a Program based application. A program is a time and rules based incentive such that when a participant within a program meets a set expectation they receive a reward. A client can have many programs at any given time. Hierarchy

Step 1 Setting up a Client

If this client has had programs in the past they may already exist in the list of available clients, in which case this section can be skipped.

1. Click “Client” from the global navigation

2. From the Client page click “create client” button

3. Enter the client name in the “New Client” text box

4. Enter the client number (Maritz Billing number) in the “Client Number” text box

5. Enter the Subclient number (Maritz Billing number) to “Subclient number” text box

6. Click the “Add Client” button and wait for the saved confirmation at the top of the page

To add a Sub-Client

7. Select the existing client from the list and (this will automatically fill the Client Number text box)

8. Enter the name of the Subclient in the “New Client” text box

9. Enter the Subclient number (ABS number) to “Subclient number” text box Click the “Add Client” button and wait for the saved confirmation at the top of the page.

TIPS: Tip: The entries are not editable and can never ever be deleted (always check for typos before clicking add).

Note: When adding subclients it is not enough to use the same Client Number in the “Client Number” text box, it must be selected in the available list.

Step 2 Setting up a New Program

1. Select the Programs from the top of the global navigation

2. Click on the “Create Program” button to open the Create Programs page

3. Select the client name from the drop down box

4. Browse for the client logo (if the client has provided one) Note: this logo is not part of the image library.

5. Enter the Program ID

6. Enter the Program Name

7. Select a theme from the “Program Theme” drop down list. If the theme is custom select Other from the drop down and then enter the name of the theme in the “Other Theme Name” text box. Note: If the program is discretionary awards upload, select None from the drop down.

8. Select the “Account Manager's Name” from the drop down list (if this information is not in the WSG, select the house account)

9. Select the “Account Manager's Start Date” from the calendar drop down. This date must fall within the program start and end dates. Note: A date must be entered even for house accounts.

10. Select the Program Start and End dates from the drop down lists.

11. Pick the first month of the client's fiscal year from the “1^{st} Month of Yearly Cycles” drop down box. (This information is used for setting up quarterly and yearly rules).

12. Set the Program Status drop down to Active.

13. Select the Program Type from the drop down list. Note: Selecting a type of program will not limit the set up of another program type.

14. Click the Save button and wait for save confirmation at the top of the page.

TIP: If a program is set to inactive the program is not visible on site coordinator. This feature can be used to limit the programs shown on site coordinator to only those currently in use. This will keep things organized and make programs easier to find.

Program Name appears on all reports.

Program Dates or some sub set appear on all PDF reports.

Program Themes appear on the Payout Result Report Objective Report

Enrollment Report

Step 3 Setting up the Hierarchy

1. Select the Programs from the top of the global navigation

2. Click the ratio button to identify the program

3. From the global navigation go to the drop down under programs and click Hierarchy Note: if there is no program selected on the program page the screen will not change.

4. The current Hierarchy will be displayed on the page

To add Hierarchy levels

5. Click the “Add level” button

6. From the Add Hierarchy Level page select the Level from the drop box

7. Add the name of the Level

8. Add the name of any volume groups within the level (these are not true volume groups but groups one level down in the hierarchy).

9. Checking the Site Coordinator box has no current functionality.

10. Click Save and wait for the saved confirmation at the top of the page.

11. Repeat this process by clicking the “Next Level” or “Add Level” buttons until all the hierarchy levels have been added.

12. Click View List to see all created hierarchy levels

To Edit or add groups to existing hierarchy levels Click the name of the hierarchy level and follow steps 7-10 above. Note: Volume groups are subsets of a hierarchy group. If volume groups are used all the participant in that hierarchy will be enrolled in one of the groups but not directly at the hierarchy level.

Note: Since the volume groups are a composite of the hierarchy level they reflect any level below can report to them as it would any other hierarchy level.

Note: Program hierarchy cannot be deleted, and must remain constant after the first enrollment file has been loaded.

Note: Participant performance calculations and point processing are linked to the most recent hierarchy structure PRIOR to point issuance.

Tip: To further break out the groups within the hierarchy use the custom fields on the enrollment template—this will not create another of hierarchy but a filterable attribute that can be used to differentiate members within a volume group. Example geographically, by job title, etc. Hierarchy is used to define views—reports can be viewed of all participants in a lower level of the hierarchy structure.

Section 2 Defining Products

Setting up the products and the product template Products are any metric used to measure performance. A product template must first be established before creating new products. Step 1 shows how to set up the fields that will be used to setup products. Step 2 shows the product setup.

Step 1 Setting up the Product Template

Setting up the Product Template.

1. Select Programs from the top of the global navigation

2. Click the ratio button to identify the program

3. From the global navigation go to the drop down under programs and click Products.

4. Click on the “Define Product Fields” button

5. The fields shown are suggested data that a majority of clients use in identification of products. Changing the label on any of these fields will change the labels on the template used in setting up new products and provide the flexibility of using client naming conventions.

6. Checking or un-checking the “Show” boxes decides whether or not the fields will be visible on the template.

Click Save—this will automatically launch the Add Product Information Page. Note: Any changes are made to the labels they will effect all products within the program, if it's change it on one it's changed for all.

Note: The date field is the only exception for numbers 6 and 7, the show field is always marked required and this field does not appear on the product template. It is always a required masked (mm/dd/yyyy) field and appears on all performance uploads (batch and online). The date label can be altered but it still record the date of performance for all claims.

Step 2 Product set up

An award product is the metric performance is measured against.

1. Select Programs from the top of the global navigation

2. Click the ratio button to identify the program

3. From the global navigation go to the drop down under programs and click Products.

4. Click on the “Add a Product” button

5. Add the product code (sku) provided by the client

6. Add the Name of the product

7. Add the Unit of Measure (units, dollars, cases, pounds, etc)

8. The “Audit Required” check will enforce every uploaded performance record be manually approved through the site coordinator. Example: If there are 8000 serial numbered items, then there will be audit 8000 claims.

9. The field defined used here were defined in the previous step. These fields have 4 options that can be set. Note: Required fields will be required on all performance claims (batch and online) if not check the field will be appear on the performance report but will be optional.

a. Dup Check Claim checks that a claim with multiple products doesn't contain duplicates items at the time it's recorded

b. Dup Check Program checks that claim with multiple products doesn't contain duplicates within the entire program (Example: a serial number isn't already on a claimed within the system by the individual or someone else.)

c. Edit Mask can be set to constrain what can be entered into a field. The field can be set to accept number, letter and/or characters in a sequence. This is very helpful in keeping down errors in serial number or invoice numbers. See Appendix for help with masks.

10. Enter a product description that will help others understand the product. This description does not appear on any reports.

11. Click Save and wait for the confirmation at the top of the page.

Clicking “View List” from this screen show a list of all products. Note: All products will appear in a drop down box for Online Claims.

Note: If a product requires a serial number then only a quantity of 1 will be accepted at time of claim. Product name and code (SKU) appear on the

Program Progress Report

Management Summary Report

Payout Result Report

Executive Summary

Section 3 Defining Awards Types

This section covers setting up award types and associating them to programs. Award types are what the participant earns for successfully completely the program. Award Fulfillment Groups are defined awards that can be used for multiple programs. They can have specific descriptors related to the program or directly to the participant within a program. Participant specific attributes will become part of the enrollment template so that the information can be gathered at time of enrollment.

Step 1 Setting up an Award Fulfillment Group

1. Select Programs from the top of the global navigation

2. Click the ratio button to identify the program

3. From the global navigation go to the drop down under tools and click Award Maintenance.

4. Click on the “Create new Group” button

5. Enter the name of the group in the text box

6. Click the “Enabled” check box to active the new group.

7. Click the “Single Select?“check this box if categories need to be limited to a single choice.

8. Enter the Name of the category.

9. Enter a description of the category.

10. Click the Save button

11. Click the “Add an Award Type” button. Note: This adds a type to an award group was well as other information.

12. Select a Category from the drop down box

a. Token is a value of 1 or 0

b. Integer is a numeric field

c. Decimal_{—}1 to 4 are numeric field that can accommodate up the chosen number of spaces behind the decimal.

d. US_Dollar is a monetary field

e. US_Date is a mm/dd/yyyy field

13. Select a Fulfillment Adapter. Note: An adapter is what's used to communicate with the company the award will be order from. The current choices are the ABS Adapter or an Excel Spreadsheet that can be downloaded with the information.

14. Enter an ID—this is the ID needed by the vendor to fulfill the order.

15. Enter the Award Name

16. Select the format from the drop down box

17. Enter a description of the Award.

Click the save button, this will launch section to input program attributes, required fields, and participants attributes, these are in coved in the next step. Note: Once a Fulfillment group category, that as been identified as single select, and participants have had made performance claims associated to it, the category can no longer be changed.

Step 2 Setting up Program or Participant Specific Attributes and Associated Required Fields

1. From the Maintain Award Type Page To Set up Attributes

2. Click on the “Add a Program/Participant Specific Attribute” button.

3. Enter the Name of the Attribute.

4. Owner and Target are predefined fields.

5. Select the Format from the drop down list.

a. Token is a value of 1 or 0

b. Integer is a numeric field

c. Decimal_1 to 4 are numeric field that can accommodate up the chosen number of spaces behind the decimal.

d. US_Dollar is a monetary field

e. US_Date is a mm/dd/yyyy field

6. Select either list, range, or none from the “Constraint” drop down list.

7. If list or range were selected enter the “Constraint Values” and click the “Add value” button. ( Example for shirts a list might contain S, M, L, XL.) Note: Only Token, Integer, Decimal and Text fields will allow constraint values to be added.

8. Enter a Default value, if necessary.

9. Click the “Save” button.

10. To Set up Required fields. Note: The required fields are all fields standard to the enrollment template.

11. Check the boxes for fields that need to be required to successful fulfill this award type. Once checked these field will become mandatory on the enrollment template for any program associated to this award.

Note: Participant specific attributes will be added to the enrollment template when the award type is associated to a program

Step 3 Associating an Award Type with a Specific Program

1. Select Programs from the top of the global navigation

2. Click the ratio button to identify the program

3. From the global navigation go to the drop down under Programs and click Program Awards. This will display a list of awards already associated to this program.

4. Click on the” Select Program Awards” link.

5. Select the Group and Category award to be associated with the program. The awards in the first box with check will allow multiple selections. The individual boxes below are the single select groups.

6. Click the “Save” button to launch the Configure Program Awards page.

7. Enter the information for any Program Specific Attributes at this time. Note: If the ABS or IFS awards have been chosen enter the ABS Project and Sub-Project numbers at this time.

8. Click the “Save” button and wait for confirmation at the top of the page.

Note: Once associate these awards will available for set up on rules section and on via recognition manager

Section 4 Creating Rules

Rules are used to calculate awards. Step 1 of this section shows all things common to every rule, the addition steps are the specifics of each rule. Step 3 covers uploading rule based objective. Note: Awards types must be setup and associated to a program before rules can be set up.

Step 1 Setting up the Homogonous Sections of the Rule Template

These steps apply to all rules.

1. Select the type of rule from the “Add New Rule” drop down.

2. Click the “Go” button.

3. Add “Rule Name” this text will appear on the following reports (working on the list)

4. Identify the participants of the rule by selecting them from the drop down box marked “Participants in” (these are listed by the hierarchy set up in Section 1 or from customized fields created on the enrollment template in Section 5)

5. Enter Qualifiers if any. Note: Qualifiers are a goal that must be met before the participant is eligible to earn any awards. Note: Awards cannot be calculated off objectives alone, they are a starting point other than 0 for in the rule to begin. Example Selling 10 items before even starting to work toward a threshold. Note: A rule can have multiple qualifiers for different products for different products within the same rule.

a. Select a product from the “with” drop down box

b. Select whether the qualifier will be at least, at most, between, or equal to from the drop down.

c. Enter the quantity to be matched or exceeded in the text box

d. If between was select from 7 then enter the maximum number in the “and” text box.

e. Click percent of objective if this is required for the qualifier. For more information on objectives see Section 4.

6. To enter another qualifier click the “Add Qualifier” button. Note: there is no limit to the number of qualifiers allowed.

7. Enter the date the rule will begin in the “from” text box Note: all dates within the platform are entered in the (mm/dd/yyyy) format.

8. Enter the date the rule will end in the “until” text box . Note: If the client is using online claims a date threshold can be extended for a specified period to accept new claims after the rule cycle has finished.

9. The last text box on each rule page is the “Program Message” text box. This should contain some motivational text, or a short explanation of the rule to help the participant. Any text in this box will appear on the following reports (working on the list)

Click save and wait for save confirmation at the top of the page. Note: Rules and qualifiers are affected by objectives, for more information on Objectives see Section 4.

Note: Rules can have multiple cycles, so that the rule pays out awards multiple times. (Example, a monthly rule running for 6 months would pay out awards 6 times.) Note: The participant drop down mentioned in step 4 will not list custom fields created on the enrollment template until a participant has enrolled and populated these fields.

Rule Name and Qualifier Name appear on the:

Top Performer Report

Executive Summary

Management Summary Report

Program Progress Report

Rule Name appears on the:

Payout Result Report

Rule Description

Program Progress Report

Step 2A Dollar One—Rewards Participating Salespeople for Every Dollar or Unit Sold from the Beginning of the Program to the End.

1. Enter the quantity of awards in the “will earn” text box

2. Select the type of award to be given from the drop down next to the “Will Earn” text box

3. Enter the performance metric that must be achieved (Example: how many phones sold

4. Select the product used to achieve the metric from the drop down next to the “for each” text box. (Note: These are the products set up in Section 2)

Select the rule cycle from the drop down marked “during each” Note: the year and quarterly cycle are based on the customers fiscal year cycle that was entered on the Program Set up page in Section 1.

Step 2B Hit & Win—Allows for Individual Goals, then the Goal is Achieved they Hit and Earn an Award which is the Win.

1. Enter the quantity of award in the “will earn” text box.

2. Select the type of award to be given from the drop down next to the “Will Earn” text box.

3. Select the product used to achieve the metric from the drop down next to the “for each” text box. (Note: these are the products set up in Section 2).

4. Enter the threshold quantity in the “at” text box. Note: this is the quantity that must be earned and/or exceeded in order to earn an award.

Step 2C Top Performer—Participants Compete with Each other to Earn Awards. The Rule can Pay the Top Specified Percentage or the Top Ranking of Participants.

1. Select the appropriate radio button to distinguish if the rule will have a ranking of top performers (Example the top 1 to 5)or a top percentage of performers (Example top 10%).

2. If the top percentage is chosen the “round up” and “round down to the nearest person” radio button will become available. Select the appropriate button so the system will round correctly.

3. Select the rating the rule will be based on from the “for” drop down. The choices are Total Performance, Incremental Performance (ask Michelle), or percent of objective.

4. Select the product the rule is based on from the “in” drop down. Note: products must be set up first.

5. Enter the quantity of award the participant will win. (Example number of points to be awarded.)

6. Select the award to be issued from the next drop down.

7. Select the rule cycle from the “during each” drop down. Note: There can be many cycle within the duration of a rule. A top performer can identified every week for a year.

Step 2D Threshold—Participants Earn a Specified Amount of Awards for Performance Over Specified Percentage of Objective. Multiple Thresholds can be Sets within the Same Program.

1. Select the Ratio button for “Over” or “At” reflecting whether the expectation is to meet or exceed the defined metric to be awarded points.

2. Enter the quantity of awards to be given in the “will earn” text box

3. Select the type of award to be given from the drop down next to the “Will Earn” text box

4. Enter the quantity of product (over or at) the objective needed to fulfill the metric and earn an award in the “for each” text box

5. Select the product associated with the quantity in number 4, from the drop down box

6. Enter the percentage of the objective that must be met to instantiate this rule

Note: Objective can be loaded before or after setting up this rule.

Step 2E Up to and Over—for Every Dollar or Unit Sold Toward an Objective, a Participant Earns a Set Award. For Every Dollar Unit Over that Objective the Award could be Different but will be Still be Earned.

1. Enter the quantity of awards to be given in the “will earn” text box

2. Select the type of award to be given from the drop down next to the “Will Earn” text box

3. Enter the quantity of product (less than or equal to) the objective needed to fulfill the metric and earn an award in the “for each” text box

4. Select the product associated with the quantity in number 3, from the drop down box

5. Enter the percentage of the objective that must be met to instantiate this rule

7. Enter the quantity of awards to be given in the “will earn” text box

8. Select the type of award to be given from the drop down next to the “Will Earn” text box

9. Enter the quantity of product (less than or equal to) the objective needed to fulfill the metric and earn an award in the “for each” text box

10. Select the product associated with the quantity in number 9, from the drop down box

The percentage of the objective is set at 100 percent.

Step 2F Manager Override—A Manager Earns a Percentage of the Average Points Earned by their Direct Subordinates (as defined within the hierarchy structure).

1. Select to award to given from the “will earn” drop down box

2. Enter the percentage to be awarded in the “equal to” text box

3. Select whether the award will be based on a total or average of participant earnings from the drop down box.

4. Select the rule cycle from the “during each” drop down. Note: There can be many cycle within the duration of a rule. Example: A percentage can be calculated on a weekly basis every week for a year.

Manager Override Management Report

Manager Override Participant Report

Step 3 Objectives

Objectives are not required but can be set for any rule. An objective is a goal or level to be met. A participant can achieve a percentage of a set objective to begin the program and/or to receive an award. Example: A participant needs to sell 100 cell phones before they are eligible to be part of the top performer contest (rule).

1. Select Programs from the top of the global navigation

2. Click the ratio button to identify the program

3. From the global navigation go to the drop down under programs and click Objectives.

4. Click on the “Download Template” link. This will launch a predefined Excel spreadsheet. The column headings are as follows:

a. Product Code—or sku provided by the client

b. Cycle—length of the objective, acceptable input is Day, Month, Year, Quarter, or Program (all title case)

c. Begin—Date (mm/dd/yyyy)

d. End—Date (mm/dd/yyyy)

e. Quantity—count of metric to complete objective

f. Type—who the objective is direct at, acceptable input is individual, group, or program (all lower case)

g. Hierarchy Level—If the type was program or group this will be a required field

h. Group—if the type was group then this will be a required field

i. Participant ID—if type was individual this will be a required field.

5. To upload the spreadsheet click Browse and find the file.

6. Click upload.

Check the results of the upload in the upload in the Batch Summary section.

Note: Once a spreadsheet is uploaded it cannot be accessed from the platform, management of originals is vital.

Note: With any spreadsheet upload, If there are errors they need be corrected and the entire file will need to be uploaded again.

Note: There is currently no way to view uploaded objectives from the platform. To see what objective exist within a program run the Programs Objective report, for more information see Section 7.

Objectives Report

Section 5 Configuring Enrollment Options

The Enrollment template must be set up for all participants in the programs. The fields marked required and show, and any label changes will be reflected on the batch enrollment and all online enrollment. Additionally online enrollment will be activated from this section.

Step 1 Setting up the Enrollment Template

1. When the auto enrolled checked box is marked it allows all participants to be enrolled with an EN status. This will remove the EN/CT/IA fields from the spreadsheet and/or online enrollment template.

2. There are two columns of checklists, the “Show” check boxes control whether or not the field (text box) will be visible on the enrollment templates (batch and online). The “Req'd” column of check boxes control whether or a field (text box) will be a required field for enrollment. If a Req'd field is checked it will automatically activate the check box in the “Show” column. This is to ensure that all required fields are visible on the enrollment templates.

3. The first 5 fields are predefined as Required and Showing on all templates. The label for Participant ID can be changed in the text box if there is a more client based name. Example it could say Dealer Name (on the enrollment template it will accept letter or numbers).

4. The next field is the Mailing Address or Business address fields, at least one field is required for all programs.

5. The Tax ID field is used for entering a SSN or Company Tax ID number then the client requires it for reporting purposes (find out which report it appears on)

6. Current Email Address

7. The next three fields have dual purposes

a. The labels can be customized to gather any specific information about a client. The defaults are Job Title, Job Grade, Company Name but they could be changed to Region, Location, Years of Service. Any pertinent data that needs to be collected about a participant.

b. The second use for this field is to further break out hierarchical and/or volume groups. If there are multiple participants enrolled in a hierarchy and they need to be differentiated by some particular trait, data can be identified here to filter them to a lower level. Example (there is a hierarchy group named Regional Manager and there are volume groups within that hierarchy named Central, East, and West but each region has multiple stores this field could be customized to a store number or store location. Note: Rules can be based off this information but, at least one participant must enrolled with an entry in the field before it will appear in the rules drop down box.

8. Online Enrollment Facilitator Flag—an OEF is a participant that is created so that others can enroll under them. Note: only applicable for online enrollment.

9. The Login ID—must be enabled for PAX Communications

10. Login Password—the password field requires something be entered even if it's not activated as a show or required field. Note: If the default password is removed, the system cannot generate another password for this program. Using the default allows the system to set a flag telling the participant to update their password at time of enrollment.

11. Custom fields from Fulfillment awards will be show here.

Note: required fields are identified by a * next to the field on the online enrollment template, however batch upload spreadsheets do not identify required fields.

Mailing Label Report using the same field names.

Step 2 Configuring Online Enrollment

1. Select Programs from the top of the global navigation

2. Click the ratio button to identify the program

3. From the global navigation go to the drop down under programs and click Online Enrollment.

4. To activate online enrollment check the first box labeled “online enrollment”

5. To activate the Terms and Conditions page on the PAX site click the box labeled “Terms and Conditions” Note: when the participants attempts to online enroll there will be a “terms and conditions link at the bottom of the page but it does not enforce that the user accept, only offers content (that has to be written)

6. If the OEF will get a link on the PAX that says “Enroll Team” this will allow the OEF to download a spreadsheet template, enter the relevant information, and upload the template enrolling participants at any level below the OEF.

7. If the “OEF must enroll before participants can enroll box is checked it enforces that the OEF must enroll before any participants below he/she can enroll.

8. If the “OEF can activate or deactivate participants” this functionality has is not yet available.

9. If the “OEF participant ID required to enroll” box is checked it enforces that the OEF participant ID will be required for all participants enrolling under all OEF's within the program. Note: this does not override number 7, in that situation the OEF can be in a created but not enrolled status and have a participant ID.

10. Enter the Enrollment code that will be used by participants for online enrollment in the “Enrollment code” text box. Note: This is not part of number 9 and it is a required field for online enrollment.

11. If the “Effective date for all Online Enrollments” box is checked is it will require an effective date be entered in the text box below it. The combination of these fields will automatically set the enrollment date for online enrollments to this date. The mask is (mm\dd\yyyy).

12. To complete click save and wait for the save confirmation at the top of the page.

Note: Changing this effective date in number 11 not change the effective date on participants that are previously enrolled

Section 6 PAX Site Permission and Communications

Setting up Emails for Participant Communications. There are two type of emails, event based and time based. Event based emails are triggered and sent automatically at the time an event happens. Times based emails are scheduled and usually send at 8 pm on the scheduled date. Times based emails can be set for one time use or to be repeatable.

Step 1 Enabling the PAX Site. Turning on Communications, and Identifying Administrators

1. Select Programs from the top of the global navigation

2. Click the ratio button to identify the program

3. From the global navigation go to the drop down under programs and click Part.Communications.

4. The first box is marked “PAX Communications” can be enable or disabled. When enabled the PAX will be visible to the PSA at time of login, this will also enable email functionality. Note: This has no effect on SC.

5. The following section allows for the permission to be set enabling the Pax Site Administrators (PSA's)

6. Pick the name of the PSA from the box of Available Administrators and either double click or click the right hand arrow to move the name to the “Selected Administrator” box.

7. To add a new administrator click the “ADD” button in the center of the of the available and selected administrators lists.

a. Enter the adm's first name

b. Enter the adm's last name

c. Enter the adm's Login ID

d. Enter the adm's Password

e. Reenter the adm's password for confirmation.

f. Click Save (Note: Scroll down to see the save and cancel buttons).

8. Enter the URL of the PAX site the format is clientname.incentiveshq.com (Example: sun.incentiveshq.com). Note: do not include http:// in front of the URL.

9. Select the Language to use from the drop down. Note: There are several languages listed but currently English is the only one that works.

Configure the addresses for program emails

10. Select either HTML or Text for the email type. Note: the default is HTML Note: Text will eliminate any formatting or themes within participant email. Note: text is used primarily with clients using lotus notes.

There are 4 boxes for email addresses

11. Enter the email address that will be sending the emails to clients.

12. Enter an Alias email address, this the email address that will show up in the from section of all participant emails sent during the program. Note: This doesn't have to be a real email address. Example Incentives@Martiz.com

13. Enter the reply to address. This is where the email is to be sent if the participants attempts to reply to an email they received.

14. Enter a reply to alias, as above this is only what the participant sees not the actual email address be contacted. Note: This doesn't have to be a real email address it only what the clients wants the participant to see.

The link marked Configure a the bottom of the box, is used to set up participant emails and will be covered in the next section.

Step 2 Enabling Time and Event Based Emails

1. Select Programs from the top of the global navigation

2. Click the ratio button to identify the program

3. From the global navigation go to the drop down under programs and click Part.Communications.

4. Click the “Configure” link at the very bottom of the page.

Setting up Time based emails

5. Check the box next to the email that will be sent.

6. Enter the date the email should be sent in the “Default date” text box.

7. Emails marked “Recurring” can be used again at a later date. Note: recurring implies that the email will automatically recur at some define time over and over, that is not the currently functionality. It is repeatable only in the meaning that it will still be available on the PAX site for later use by changing the date.

8. Enter a Description of what the email will contain, this will help the PSA identify the intent of the email from the PAX site.

Setting up Event based emails

9. Click the link that says “Display event-based emails . . . ”

10. A list of pre-defined emails will display. Check the emails that will be sent to participants at the time of an event.

11. Award Earned will trigger an email to very participant at the time they earn an award through a rule.

12. Emails 2, 3, 4, and 6 relate to updates on the PAX webpage. If checked every time any change is made to a webpage an email will be sent to tell participants to go see the updates.

13. Email informing the participant of their password will email the participant their password in the event they have forgot it and used the forgotten password link off the login page.

14. Emails 8 will send an email to Non-OEF participant that is in a created state and invite them to enroll.

15. Email 9 will confirm their enrollment.

16. Email 10 will send an email to a created OEF participant inviting them to enroll.

17. Email 11 will send the OEF a confirmation of their enrollment.

18. After settings are complete click the “Save” button

There will be prompt on the Configuration Participant Communication prompting to save again to commit all changes

Note: The email date saved for a time-based email cannot precede the current calendar date.

Note: the reason OEF and Non-OEF email differ is the information provided in the email. The OEF will require special instructions on things like pre-enrollment of their team and other administrative functions. All email content is configurable via the administrative portion of PAX site. See section 9

Section 7 Reporting

This section covers reporting, there are a series of predetermined reports available to the system. Step 1 will cover running a report from the VAR site. Step 2 will cover how to make reports available to a participant from on the PAX site. Reports are generated in a PDF format. A participant can view all reports for other participants enrolled under them but this must be activated through the PAX permission to be visible on the site. See Section 9 for more information.

Step 1 Running a Report from VAR

1. Select Programs from the top of the global navigation

2. Click the ratio button to identify the program

3. From the global navigation go to the drop down under programs and click Reports

4. Select the report type from the drop down.

5. Some reports that are based will replace the “Run Report” button with a “Configure” button.

a. Chose the begin and end date.

6. Click the “Run Report” button.

Continue clicking the “Refresh” button until the status shows complete and the filename is available.

Step 2 Configuring Reports on PAX

Configuring Reports for to be available to Participants via the PAX site. A Participant with subordinates will automatically receive Management reports such as Program Progress reports, Management Summary reports. They will also be able access Claim Summary Reports, and Program Earning reports specific to an individual. These reports can be restricted to specific cycles within the rule to set the dates on the dates on this step covers setting those dates. The subordinate views must be enabled though PAX site permission for the reports to be visible.

1. Login a PSA and the go to the Admin section of the PAX site.

2. Select “Reports” from the global navigation under the administrative home section.

3. Select the “view reports” link next to the rule.

4. Select the radio button for the cycle to be show on the PAX site.

5. Repeat numbers 3 and 4 until all reports that need to be viewed are updated. Click the “Save” button and wait for confirmation at the top of the page.

Note: The configurable reports are listed by the rule name and cycle. Rules having a daily cycle will have daily reports available by date, but only one report at time can be made accessible to the participant.

Note: The reports associated with cycles will not automatically update with the date so they must be manually updated at the correct cycle.

Section 8 PAX Site Aesthetics

PAX site Aesthetics refers to the look and feel of the page. The first section covers loading the image library, the following section explain how to change the colors of font and the placement of navigation.

Step 1 Uploading Images to the Image Library

To upload an client logo into the image library

1. Select Images from the content management section of the global navigation

2. Browse for the file containing the logo

3. Enter the Height (if known)

4. Enter the Width (if known)

5. Enter a Caption to clarify who the logo belongs to.

6. Click the “Upload button”

Note: The height and width parameters in number 3 and 4 are only to record the size of the image. They will not alter the size of the image in any way.

Note: Maximum image size is 250 K

Note: Number 3, 4, 5 are not required fields.

Note: BMP and JPG are the preferred files types but TIFF and GIF are also acceptable.

Step 2 Adding a Client Logo to the PAX Homepage

1. navigation

2. Click on the blue box marked “click here to view/select images”

3. Select the image “Category” from the drop down. Note: The first four categories of images are accessible from any program. The category marked client images will only contain the images specific to the client that owns the program associated to this PAX site. Currently in the staging environment used by development all client images are visible to any PAX site.

4. Select the “Sub-category” (price range or type of image) from the second drop down

5. Click on the Search button

6. Select an image by double clicking on it.

7. To preview the image click the “Save” button then the “Preview” button.

8. If the image was unsatisfactory click reset or delete and return to step 2.

If satisfactory, exit this screen by selecting another function from the global navigation.

Note: The image will be located in the top left hand corner and will not resize. A preview is recommended.

Client logo's will be visible on all reports in a PDF format

Step 3 Changing Themes and Layouts

1. Click directly on the words Administrative home on the global navigation.

2. The “Pax site is” select will enable or disable access to the site.

3. To change the page layout of site select a different layout from the drop down box.

4. To change the theme of the site select a new theme from the drop down box. Click the “Save” button and wait for confirmation a the top of the screen.

Note: If the layout or theme is changed ALL existing content will be lost.

Themes are on the:

Payout Result Report

Objective Report

Enrollment Report

Step 4 Configuring Navigation—this Controls the Placement and Availability of Buttons for the PAX Interface

1. Select Main Navigation from the Administrative Home section of the global navigation.

2. To enable a button and have it show on the PAX site click the check box under “Enable” Note: There are three required buttons HomePage, Signoff, and Admin that cannot be disabled.

3. To change the order and/or location of a button, change the pixel count in the “Location Top” and “Location Left” text boxes. Note: 0 in both fields will move the button to upper most left hand corner. To have visible buttons at all times it is not recommended to have a pixel count greater than 800 for any button.

4. To change the label on any button type in the new label in the “Button Text” text box associated to the button that will be changed. Note: Changing the button label will not change how it is linked from the homepage. Example changing the Rules label to Dealers will not change that it will still launch the Rules Page when someone clicks on it.

5. The button labeled Program Initiatives will become the Recognition Manager button. If this is a RM program change the label to Rec Manager.

6. To preview the location of buttons on the website, Click the “Save” button, then the “Preview button”.

7. To return buttons to their previous locations click the “Reset” button.

8. If satisfactory, exit this screen by selecting another function from the global navigation.

Note: The Admin button is only visible to those logged in as PSA.

Tip: The content of any page can be changed. If there is a need to have a page other than what is offered and there is a page not enabled. Changing the button label and content of page can have the same result as creating a custom page.

Step 5 Changing the PAX Site Colors and Fonts

1. Select Style form the from the Administrative Home section of the global navigation

2. Select the background color from the “Background” drop down box. Note: the codes next to the colors are referred to as Hex codes.

3. Select the default color of the Text on the on the webpage.

4. Select the Menu Background color (this is the color behind the navigation buttons)

5. Select the Menu Text color (the color of the lettering of the navigation buttons)

6. Select the Menu Text Rollover color (the color of the navigation lettering when it is it is activated by the mouse rolling over it)

7. Select the Selected Menu Text color (the color of navigation lettering for the page that is being viewed)

Select the default font.

Tip: Text fonts and colors can be changed for individual sections of text using HTML in the content sections.

Step 6 Setting up Aesthetics for a Recognition Manager Site.

RM adds a several links for recognitions and they must first be enable then positioned. The pages themselves are the configured the same as any content rich page. See Step 2 in this Section for more information

1. Select Page Options from the Administrative Home section of the global navigation.

2. Check the first box to make a RM link available from any page.

3. Check the second box to make a RM icon available from any page.

4. Check the third box to make the participant award balance available from any page

5. Check the fourth to make a welcome announcement available from any page.

6. Check the fifth box to enable the alerts in number 7 and 8

7. Check the sixth and seventh boxes to enable the display of alerts when recognition are received or approved recognition.

8. Click the “Save” button and wait for the confirmation at the top of the page.

9. Select the RM Page or the Homepage from the Content Management section of the global navigation.

10. The enabled links will appear in the bottom section the page. Check the enable box for the link that should on the selected page.

11. Set the location of the link or icon. Note: 0×0 is the upper most left corner and 800×600 is the lower most right hand corner.

Click the “Save” button and wait for confirmation at the top of the page.

Note: The terms and conditions link is only available with online enrollment and must be from the VAR site to be active

Section 9 Managing PAX Site Content

Content can be set for everyone or can vary on any page by hierarchy level, volume group, contact group, or custom level. The set up of any configurable page is the same, so it will be covered once. Step 1 will cover how set permission that access to content for editing. Step 2 will cover configuring and maintaining content rich pages. Step 3 will cover text only pages.

Step 1 PAX Site Permissions—Permissions can be Modified by Role, Group, or Member

1. Select Permissions from the Administrative Home section of the global navigation To configure permissions for a role.

2. Select the radio button marked “Role”

3. Select the role to modify from the drop down. The available roles are PAX Site Administrator, Content Manager, and Participant.

4. The permissions list has two columns “Allow” and “Deny” Check the fields that the intended role will have permissions to modify. Note: Everyone is denied unless allowed so no checks are necessary in the deny column at the role level.

5. The permissions that can be allowed at the role level include:

a. Permission to view subordinates (any level below themselves)

b. Permission to manage the webpage content for different hierarchy, volume groups, and custom level groups created through the custom fields on the enrollment template in Section 5.

c. Permission to submit online claims.

6. Click save and wait for confirmation at the top of the page

To configure permission for a group.

7. Select the ratio button marked “Group”

8. Select the group to modify from the drop down list. The available groups are hierarchy levels, volume groups, and custom level groups created through the custom fields on the enrollment template in Section 5.

9. The permissions list has two columns “Allow” and “Deny” Check the fields that the intended role will have permissions to modify. Note: Everyone is denied unless allowed so no checks are necessary in the deny column at the role level.

10. The permission that can be allowed at the group level include:

a. Permission to view subordinates (any level below themselves)

b. Permission to submit online claims Note: if this is allowed at the role level for all participants it is not necessary to check it again here for each group).

11. Click save and wait for confirmation at the top of the page

To configure permissions at a member level.

12. Select the radio button marked “Member”

13. Enter the members login ID and click the “Go” button”

14. The permission that can be allow at the member level include: Note: If the member is not a PSA they will not have access to the Admin functionality of the system and even allowing them content permissions will not allow them access to that portion of the site.

a. Permission to view subordinates (any level below themselves)

b. Permission to manage the webpage content for different hierarchy, volume groups, and custom level groups created through the custom fields on the enrollment template in Section 5.

15. Click save and wait for confirmation at the top of the page.

Note: The role of content manager can only be set manually through the database at this time.

Note: If the “allow” box is not checked there is no way to access the content on any page, even for a PSA.

Tip: If online claims is active for this program make sure to check “allow” for the permission labeled “submitOnlineClaims” to make the link accessible to everyone. This can be disabled at the group level when necessary.

Step 2 Configuring and Maintaining Content Rich Pages

1. Select Select Group from the Content Management section of the global navigation.

2. Select the group for which the content is being configured is targeted, from the drop down list

3. Return to the global navigation and the select the type of page to be configured (Example: Homepage, Rules Page . . . etc) Note: The intended audience is shown at the top of the page.

4. The HomePage, Rules Page, FAQ, Awards Page, and the Contact Us Page contain the same modifiable fields. Note: The Contact us page contains no images or text positioning.

5. The Make Content Live check box, allows content to be developed and saved while not being accessible to the site. When all content for the page is complete checking the box will move the content to the website.

The text sections contain:

6. Paragraph headline field which is automatically bolded on the website.

7. Insert Link drop down box. This contains links to any custom pages that were created within the program. To insert link into the paragraph text select link from the drop down box then select the link location within the paragraph text and click the “Insert” button. This automatically adds the necessary HTML tags to the text.

8. A section of editable content via the Paragraph text box.

9. Paragraph positioning boxes to adjust the size and location of the text on the website. Note: The default settings are pre-adjusted for the chosen theme. Note: The Paragraph headline will adjust to stay with the paragraph text.

10. To remove a section simply click the “Delete Section” button. Note: This will not affect the positioning of other text and images on the webpage.

The image sections contain:

11. The ability to use images stored in the image library. See Step 1 of this section.

12. A text box to enter a caption that will appear under the image (modifiable with HTML).

13. Image positioning boxes to adjust the size and location of how an image appears on the website. Note: The height and width of the image may have been automatically filled with information entered at the time the image was added to the library. These can now be used to resize the image but this will affect the image quality, a preview is recommended.

Adding Sections

14. Additional Text section and image sections can be added by click the appropriate buttons at the top of the page. Note: at this time there are no limits to the number of text sections of images allowed on a page.

Adding Links to a page. Note: Links will show on the left side of the webpage being edited.

15. Enter the URL of a webpage.

16. Enter the text that link will display. ) Example www.martiz.com might show as Maritz.)

17. Click the “Add/Update” button. Select the link to update and click the “Edit” to edit the URL or text.

Note: The content developed will only be accessible to the group selected. There is currently no way to change the an existing page to everyone or to target a different group after it has been entered (except to cut and paste all the text and re-upload the images.).

Note: To Preview changes the page must first be saved.

Note: The screen resolution will affect how the layout is viewed by a participant. The recommend resolution is 800×600.

Note: If the event based emails for email announcements are activated every time the make content live box is checked an email will be sent to EVERYONE (no exceptions) at the level for which the content is available. These emails contain default content but can be modified via email content management.

Note: For other fields such as Recognize Someone icon see Section 11 for information on the set up of Recognition Manager

Step 3 Configuring and Maintaining Text Pages

1. Select Select Group from the Content Management section of the global navigation.

2. Select the group for which the content is targeted, from the drop down list

3. Return to the global navigation and the select the type of page to be configured (Example: Contact Us, Terms and Conditions, and Enrollment, etc) Note: Terms and Conditions are only applicable with online enrollment.

4. Enter text with HTML if necessary.

5. Click the “Save” button and wait for the confirmation at the top of the page.

Note: The terms and conditions link is only available with online enrollment and must be from the VAR site to be active.

Step 4 Set up and Maintenance of Time Based Email Content

1. Select Emails from the Content Management section of the global navigation.

2. Select the “edit” next to the email to be modified. Note: for a time based email to appear in the in the list is must first be set up on VAR, Section 6.

3. Select the groups and hierarchy that will be the audience for the email. Note: The email will be sent to EVERYONE in the selected group, no exceptions.

4. Enter the Date the email will be sent. Note: Date must be in the future.

5. Check the “Themed” box for the program associated theme to be include in the email.

6. Enter the Subject that will appear in the participant email subject line.

7. Enter the email content. This will appear as plain text if no HTML is added or if text only email was select in the VAR set up.

8. Use the insert drop down to add information about the program. This will automatically insert the correct text for the groups being addressed.

9. To insert images into the email click inside the blue box and select the image to be included. Note: Image must exist in the image library, See Section 8.

10. Click the “Add Update” button to add the image to the email.

11. Click the “Save Email” and the “Preview” email to have a preview email sent. Note: the preview email will be sent to the address set up for PAX Communication in Section 6.

12. To finish click the “Save and Exit” button and wait for the confirmation at the top of the page.

Note: The terms and conditions link is only available with online enrollment and must be from the VAR site to be active.

Note: All scheduled time based email are sent at 8pm on the date requested.

Step 5 Set up and Maintenance of Event Based Email Content

1. Select Emails from the Content Management section of the global navigation.

2. Select the “View Event Based Emails” link.

3. Select the “edit” next to the email to be modified. Note: for a time based email to appear in the in the list is must first be set up on VAR, Section 6.

4. Check the “Themed” box for the program-associated theme to be include in the email.

5. Enter the Subject that will appear in the participant email subject line.

6. Enter the email content. Most Event based emails contain default content. This can be edited.

7. Use the insert drop down to add information about the program. This will automatically insert the correct text for the groups being addressed.

8. To insert images into the email click inside the blue box and select the image to be included. Note: Image must exist in the image library, See Section 8.

9. Click the “Add Update” button to add the image to the email.

10. Click the “Save Email” and the “Preview” email to have a preview email sent. Note: the preview email will be sent to the address set up for PAX Communication in Section 6.

11. To finish click the “Save and Exit” button and wait for the confirmation at the top of the page.

Note: The terms and conditions link is only available with online enrollment and must be from the VAR site to be active.

Note: Event based emails are sent to EVERYONE enrolled in the entire program, No exceptions.

Note: There is no required date and if active and a change is made they will be sent with default content

Section 10 Day to Day Operations

This section covers day to day operations of an ongoing program. Step 1 will cover using site coordinator. Step 2 will covers the basics of doing batch uploads. Step 3 shows to enroll a participant. Step 4 is recording performance and Step 5 introduces award calculation and issuances.

Step 1 Using the Site Coordinator to Obtain Participant Information

1. Select the radio associated to the program being updated. Note: To resort the list by the Program Name, Client Name, Status or Type click the link about the list type.

2. Click the “Select” link.

3. Click on the “Administration” button. Note: The other buttons are not active at this time.

To obtain information about a participant

4. Click the “participant information” button on the left side navigation

5. Click the link marked “Participant ID”.

6. Enter the Participants ID or the first few letters of the first or last name and click the “Search” button.

7. Select the radio button next to the name of the person being searched.

8. Click on the “Accept” link and the participant's information will be displayed.

9. Use the links next to the personal information heading to obtain more information on this participant.

10. To search for another participant repeat steps 4 through 10.

To search for a participant

11. Click the “Search for Participant” button on the left side navigation.

12. Enter the Participants ID or the first few letters of the first or last name and click the “Search” button.

13. Select the radio button next to the name of the person being searched.

14. Click on the “Accept” link and the participant's information will be displayed.

15. Use the links next to the personal information heading to obtain more information on this participant.

To search for another participant click on the link marked “Participant ID” and repeat steps 12 through 14.

Step 2 Batch Uploads

This section covers doing any type batch upload. Batch uploads are used for uploading information related to Enrollment, Performance, and Objectives.

1. Click on the “Download Template” link.

2. Click on either the “Open” or “Save” link. Note: this is windows functionality and the specific of opening and saving will not be covered in this document.

3. Enter the information into the spreadsheet and save it.

4. Click the “Browse” button and locate the file to be uploaded.

5. Click the “Upload” button.

6. Enter the “Effective Date” in the text box. Format is mm/dd/yyyy

7. Check the status column on the Batch Summary and continue to click the “Refresh” button until the status reads Complete or Failed.

To understand the nature of a failure, check the record detail and scroll to the last column labeled errors or click the download details link.

Note: If the upload fails the entire spreadsheet must be reloaded.

Step 3 Enrolling Participants Batch or Online Through the Site Coordinator, as an Online Enrollment Facilitator, or for Recognition Manager.

1. Click on “Add/Enroll” button

2. Select “Batch or Online” button from the left side navigation. Note for batch see upload procedures in Section 10.

3. The available headings below will appear on the spreadsheet and/or the online enrollment template.

a. Participant ID—any text

b. Hierarchy Level—must be a hierarchy level set up during enrollment.

c. Reports To—The Participant ID of the person the participant will be reporting to. The report to person must be already be enrolled or must be included for enrollment on the same upload. Note: use the word TOP if the participant reports to a the top most group of the hierarchy and it has no enrolled participants.

d. Group—must be a volume group set up during enrollment.

e. First Name—any text

f. Middle Initial—one character, alpha only

g. Last Name—any text

h. Mailing Line 1—any text

i. Mailing Line 2—any text

j. Mailing City—any text

k. Mailing State—the any text

l. Mailing Zip—any text

m. Mailing Country—any text

n. Mailing Phone—any text

o. eMail Address—any text

p. Job Title—any text

q. Company Name—any text

r. Status—EN for enroll or CT for create Note: A participant cannot be enrolled at an IA or inactive status.

s. Online Enrollment Facilitator Flag—only if checked as required on the batch template will accept yes or no only. Note: This field is not visible to a Non-OEF participant performing online enrollment.

t. Login ID—participant login id

u. Login Password—participant password

v. Any fields associated to an award type. —these fields are identified at the time the program is established.

Enter the effective date and click the “upload” button for batch enrollment, or click the “Save” button for online enrollment.

Tip: Spreadsheet fields do not denote which fields are required and which are not. To identify required fields view the online enrollment template. Required fields are identified with a “*”.

Note: The available headings for the enrollment templates are identified by the choices made when setting up the enrollment templates in Section 5.

Participant ID will appear on all reports. Mailing Label Report is a consolation of all enrollments using the enrollment template

Step 4 Recording Participant Performance—Performance can be in the Form of a Batch Spreadsheet through SC or an Online Claim Using SC or PAX.

To perform a batch enrollment. See Section 10 on batch uploads. Online claims from site coordinator or the PAX site appear the same.

1. The available headings below will appear on the spreadsheet and/or the online performance template. Note: These fields come from the product template set up in Section 2. The labels on any of these fields could have been changed during set up and may read differently.

2. Participant ID—an ID of an enrolled participant

3. Claim Number—online claims only Note: leave field blank, this field can only be used if a participant did an online claim and needs to make changes to it. Use a combination of the claim number and the participant ID to view the claim.

4. Date—the date the performance is recorded (mm/dd/yyyy)

5. Product Code—see note

6. Quantity—the quantity of the product being recorded

7. Serial number—see note

8. Reference/Invoice number—see note

9. Notes—see note

10. Custom fields—see note

Approved check box—online site coordinator interface only.

Note: Product Code, Serial number, Reference/invoice number, notes, and custom field could have been masked during set up. See Product Template set up in Section 2 for more information.

Performance is visible on the:

Program Progress Report

Performance Report

Executive Summary Report

Top Performers Report

Step 5 Performing Calculations and Issuing Awards.

1. Select Programs from the top of the global navigation

2. Click the ratio button to identify the program

3. From the global navigation go to the drop down under programs and click Award Calculations.

4. Check the boxes of the awards that need to be calculated or recalculated. If everything needs to be calculated click the “Select All” button Click the “Calculate” button and remember to click the “Refresh” button until the “Calc Status field” shows complete.

5. The “Award Order” page will launch if an award has been earned the “Issue Awards” button will become available. Note: this page also is accessible from the global navigation by selecting Award Orders from under Programs.

6. To issue an award

7. Click the “Issue Awards” button

8. Check the “Accept” or “Ignore” boxes as appropriate.

9. Click the “Save” button to launch the Issue Payout Awards page.

10. Check the “Select” box next to the participant ID's that are to be paid out

11. Click the “Place” button from the Order Program Awards page. Note: This also records the date and time the order was placed.

To run a report on awards issued.

12. Click the “Select” box for the date range required on the report and click the “Run Report” button.

13. Select Reports from the Programs section of the global navigation.

Note: an “x” in the “Re-calc” column signifies that the performance has changed since the last calculation was run.

The report mentioned in number 12 is the Awards Calculated/Purchased Report

Section 11 Setting up a Recognition Manager Program

This section addresses the set up of a Recognition Manager Program. A RM Program must be associated with a Client budget. The client budget can be associated to many RM programs. Note: This section will not be complete and will only the sections that are presently built out in the development stage environment. Step 1 will show how to create a client budget in VAR and associate it to programs that will use it. Step 2 will show how to set up recognition levels Step 3 is setting up criteria. Step 4 will show how to set up budget allocation (not required) Step 5 will walk through the Recognition Program wizard to create a RM Program.

Step 1 Setting up a Client Budget

1. Select Clients from the top of the global navigation.

2. Click the ratio button to identifying the client.

3. From the global navigation go to the drop down under clients and click Client Budgets.

4. Click the “Add a Budget” button.

5. Enter a Budget name.

6. Enter a description of the budget and how it is intended to be used.

7. Enter the dates the budget will be effective.

8. Enter the name of the person that owns the budget.

9. Enter the Owners email address. Note: This email address is not currently tied to any email functionality and is informational only.

10. Enter the Upper limit of the budget.

11. Enter the Maximum quantity that can be allocated to any one program.

12. Enter the Award Type Note: This needs to the same Award type associated to the program that will be uses this budget.

13. Select the Programs to be associated and click the → to move them to the associated list.

14. Click the “Save” button and wait for confirmation at the top of the page.

Step 2 Setting up Recognition Levels. The Recognition Level will Determine the Award Type and Amount that be Given.

1. Select recognition levels from the Administrative Home section of the global navigation.

2. Enter the name that the level will refer to.

3. Enter the Display Order. This shows which order the participant will see the recognition levels.

4. Enter a description of the recognition.

5. Select an Award Type from the drop down box. Note: This list is restricted to the award types associated with the Program.

Enter the min and max quantities that can be awarded. Note: Quantities should fall within the budget constrictions.

Step 3 Establishing Recognition Criteria. This is the Criteria that can be Associated to a Nomination by the Participant Recognizing Someone

1. Select recognition criteria from the Administrative Home section of the global navigation.

2. Select the “Enable” ratio button.

3. Enter the Criteria name.

4. Enter a Description of the criteria.

5. Click the “Save” Button.

Step 4 Allocation of a Budget Across Programs

1. Select Client Budgets from the Administrative Home section of the global navigation.

2. Click of the name of the Budget to be allocated.

3. Enter the Allocation Name

4. Enter the Allocation ID

5. Enter the Budget Owners name

6. enter the Budget Owners Email Address Note: This email address is informational only.

7. Enter the amount the budget to be allocated. Note: The allocation limits and reminder of the budget are listed next to Client Budget Info:.

8. Select the radio button to determine if the allocation will be for a specific group or at a program level. Note: If selecting Programs it will include all groups listed.

9. Click the “Save” button and wait for the confirmation at the top of the page.

Step 5 Setting up a Recognition Program Using the Wizard

Setting up the Recognition Program. The wizard will walk though 4 screens Criteria. This is the criteria that can be associated to a nomination by the participant recognizing someone

1. Select recognition programs from the Administrative Home section of the global navigation.

2. Enter the Recognition Name

3. Click the “Enable” ratio button

4. Enter a Description of the Recognition Program.

5. Select the Award Type to be given. Note: This list is restricted to the award types associated with the Program.

6. Check the box if E-card will be available from this RM program.

7. Enter the Minimum/Maximum Payout Amounts. This is amount of budget allocated to this program. The amounts marked default are the upper and lower limits.

8. Enter the Payout Increment. Note: This amount must be divisible by the Maximum allowed amount.

9. Select the Eligibility from the drop down list. This determines how the payouts will be distributed. The choices are Individuals Only, Multiple Individuals, Predefined Groups Only, or No Restriction.

10. Enter the Effective Dates. Note: These dates must fall within the Budget Dates set in VAR.

11. Select the “Next” button

12. Select the Groups that can award Recognitions and the use the → to move the selection to the selected group box.

13. Select the Groups can receive Recognitions and the use the → to move the selection to the selected group box.

### APPENDIX B-1

### Salesincentivemanager^{SM}

### Features Overview

The SalesIncentiveManager's functionally is divided into three distinct components in support of a client's sales incentives program:

Program Administration

Program Management

Participant Communications

Each component is accessible via a unique Internet browser-based user interface to allow maximum flexibility in accommodating a client's program administration needs.

### Incentive Program Administration

The program administration functionality is used by Maritz Incentives (MI) to establish and administer programs operated on Maritz' Enterprise Technology Platform. Activities using this application include identification of client, project and program details, program hierarchy, establishing the program enrollment requirements, participant objectives and products (metrics/SKUs), configuring program rules and payouts, performing calculation, acceptance and issuance of awards, enabling pax communications, online claim and online enrollment features, and administering the Site Administrator/Pax Site Coordinator users. This is a web-based application accessed over the intranet, and thereby requires no installation on the “client” machine.

### Program Creation

The software allows an MI program administrator to create an unlimited number of programs that may be activated at any time. It allows the program administrator to identify the parent-client/sub client, the account manager, the valid program dates, program award type(s) and a standard or custom theme for the program. It provides a method to capture and display the client's logo on the primary pages. For each established program, the following subset of program specifics are defined:

Hierarchy Levels and Groups

The SalesIncentiveManager software provides for the identification of unlimited levels of hierarchy and groups in which to classify participants. Groups within a hierarchy level can be created to represent organizational alignment (e.g. districts) or to represent sales volume groups (e.g. rank dealerships on total last year's sales; create 4 volume groups, each representing one-fourth of the combined dealership volume). Levels and groups may be added and/or renamed, and can be deleted up to the point of enrollment assignment into the level/group.

Automated Group Assignment

This feature effects automatic group assignment of participants (e.g., Dealership Name, Job Title, Job Grade) based on participants' configurable enrollment attributes.

Enrollment Options

SalesIncentiveManager provides a standard set of configurable participant enrollment attributes. The client may define up to three custom attributes and these can also be used to identify participants involved in separate incentives rules by virtue of the automated group assignment feature described above. The enrollment attributes can be indicated as required or optional data components. Minimum required enrollment fields include:

Participant ID (form label customizable. This is the key participant identifier in the system)

Hierarchy Level

Reports To

First and Last Name

Either a Mailing Address/Phone or a Business Address/Phone (when ABS award points are selected as a program award vehicle)

Additional fields include Group (necessary if designated in program hierarchy), Tax ID (necessary for tax reporting), Email Address (necessary for email communications), Job Title (label configurable), Job Grade (label configurable), Company Name (label configurable), Login ID and Password (both necessary for online participant communications). The software supports three enrollment statuses: Enrolled, Created, Inactive. It allows for default enrollment settings including auto-enrollment. Enrollment settings may be reviewed and changed at any time by the Program Administrator

Performance Objectives

Performance objectives may be established and uploaded for each product/metric and for defined time periods (cycles) at any of the following levels:

Program (all participants have the same objective)

Hierarchy/group (all members of the hierarchy/group have the same objective)

Individual participant (each participant has an individual objective)

Product List

The software allows the program administrator to add, change, or delete an unlimited number of products/metrics/SKU's for a program. An administrator first defines the program product fields available for establishing product information (e.g. data fields such as serial number, customer name, invoice number, etc.) When adding products, the administrator then identifies which data fields are required/optional for each product when provided for performance or measurement, which products are audited when submitted as performance, and any product data fields that are identified for duplicate check.

### Standard Rule Structures

SalesIncentiveManager supports all widely used standard incentives rules structures including:

Dollar One

Hit & Win

Incremental Sales

Up To & Over

Thresholds (Sales Plateaus)

Manager Overrides

Top Performers

All rules structures can be configured with an unlimited number of qualifiers based on established program products/metrics such as a defined percent-of-objective attained for a SKU or product knowledge score. Rules structures are established to reward for performance of a specific product/metric during a defined time cycle over a defined period of time. A rule structure can be applied to ALL program participants or a specified participant audience (a defined hierarchy or group).

Dollar One

Participants earn x awards for every y units/dollars of a particular SKU.

Hit & Win

Participants earn x awards for y units/dollars (or % of objective met) for a particular SKU. Multiple earning thresholds can be established with different award payout.

Incremental Sales

Participants earn x awards for each y units/dollars of a particular SKU once performance is equal to/greater than a defined percentage of objective OR dollars/units over objective.

Up To & Over

For every unit/dollar for a SKU up to and at a SKU objective, participants earn x awards. For every unit/dollar for a SKU over that SKU objective, participants earn y awards.

Thresholds (Sales Plateaus)

Participants can earn at different rates at different thresholds for performance of a particular SKU. For example, x points are earned at 90% of objective, y points are earned at 100% of objective, z points are earned at 110% of objective, etc.

Manager Overrides

A manager earns a percentage of the average points earned by his direct subordinates (defined by the report-to enrollment attribute). The average is determined based on the total of all direct subordinates, and can be configured for a manager to earn a percentage of either the average or total earnings of his/her subordinates.

Top Performers

Awards are earned based on ranking. The top “n” participants or participants in the top n % at a given level of the hierarchy (e.g., Dealers) can earn an award. The Top Performer rule calculation and corresponding report ranks eligible participants, so that a client or MI administrator can award the prizes.

Incentives Calculations

The software provides for the calculation, acceptance and issuance of payout awards any time after the performance cycle has begun. The system will flag any rules for which awards have been calculated, accepted or issued as requiring recalculation if the system receives changes in performance data, objectives, group membership, enrollment status or subordinate earnings that may affect a manager's earnings under a Manager Override rule effective during the rule cycle date range. The platform further provides for the calculation and issuance of payout award adjustments that result from recalculations. The software provides a method to review all payout calculations for a program and the results may be provided to the client before awards are issued. The platform generates a .pdf format report of the payout calculation result details.

### Incentives Awards

The SalesIncentiveManager system supports the ability to define and enable the fulfillment of a variety of award options, including:

Award Points deposited into an award bank account

Travel

Client designated awards

### Incentive Program Management

Coordinator Interface

SalesIncentiveManager utilizes a separate web site where MI Administrators and/or Client Site Coordinators enter and edit program participant enrollment and performance data, and to process discretionary awards.

Enrollment

The software allows for both individual, on-line and batch enrollment of participants. The software allows the same person to participate in multiple programs for the same client and allows for the deposit of award points from multiple programs for the same client into a single account for the person. The software provides for adding and changing program enrollment status, enrollment attributes, reporting relationships and demographic information about participants.

Performance

The Coordinator Interface provides a method to enter an unlimited number of participant performance records both on-line and in batch uploads. It allows for both positive and negative quantities of performance. It also provides a method to review and revise a record of performance. The software allows the records of performance to be reviewed, modified, reversed, approved or rejected, as required for the client program.

Discretionary Awards

Discretionary award deposits is available via batch upload functionality to users of the Site Coordinator Interface. This allows for award point issuance to program participants independent of the calculated award earnings from rules structures.

### Participant Communications

The SalesIncentiveManager system provides a variety of methods for communicating to participants in an incentive program including a fully configurable participant program website and automated time- and event-based e-mails.

Website

Features include:

Secure participant login/password access

Client branding

Standard theme and graphical options, as well as ability to implement client-specific theme/graphics

Three site template options, as well as ability to implement client-specific template choice

Standard site navigation includes: Home, Rules, Awards, Awards Statement, Reports, FAQs, Contact Us and Profile pages

Content and image manageable on Home, Rules, Awards, and FAQs pages; content manageable Contact Us page; content dynamically generated on the Awards Statement, Reports and Profile pages.

Ability to add and link custom pages to the Home, Rules, Awards, and FAQs pages

Ability to enable specific targeted content views for participant audience groups on select site pages

A Gateway page can be developed and rendered to support participant access to multiple client programs and corresponding participant websites. The Gateway allows client level content management and provides individual participant access to all programs for which a participant, based on login, is enrolled.

Emails

Emails can be content-managed and can be configured to trigger based on defined events such as: awards earned, progress updated, website updated, etc. In addition, promotional, fully content manageable e-mails can be set to trigger on specific dates, and can be targeted to any program defined hierarchy level/group.

Online Claims Submission and Auditing

Client programs can allow for Online Claim submission via the program website. With online claim submission module, the client will have the option to define a claim. One product or multiple products (or transactions) can be included on the claim. Clients define the data fields and product field labels so the claim detail is specific to the client situation and industry. Clients can request a data field be checked for duplicate entries. The data can be verified against the program database or the client database. The fields can also be flagged for edits to ensure the accuracy of the information into the database prior to submission. These built-in data verification and validation rules are used to reduce errors and to let the user know, before the claim is submitted, that the data is acceptable or additional information is required in order for the data to be accepted.

A link from the Home Page to content manageable claim pages can be enabled for client-defined participant groups. From the website, a participant can submit performance claims for eligible program products. Corresponding Claim Summary and Detail reporting is available on the website from the Reports page.

MI/Client Pax Site Administrators have access to Perform Audit functionality for claims flagged for audit based on client-defined and system implemented criteria. Each client program will be configured as to whether auditing is a requirement, definable at a claim and/or product level. The client has the option to configure flagged claim transactions as ‘pending’ or ‘auto approved’. Audit notes are documented and performance transactions approved or rejected via the Perform Audit functionality. The statuses of transactions are automatically updated throughout the system for calculation eligibility and via online participant claim reports.

Online Enrollment

Client programs can utilize a highly configurable online enrollment functionality to support enrollment of channel partners for whom a client has incomplete data and/or who are “invited” to participate in a client program. Participants can be enrolled in a “created” status and invited to access the program url and content-manageable/client-configurable enrollment and terms and conditions pages to activate their enrollment. Participants unknown to the program database can also self-enroll when provided access to the program url and provided program specific enrollment code/enrollment ID information.

### Reporting

SalesIncentiveManager offers a broad selection of standard reports to provide information concerning the progress and performance of the participants in the incentives program. The reports are branded with the client's logo and the chosen program theme. Reports are delivered to the browser in Adobe Acrobat (PDF) format and may be printed from the browser or saved to a file for distribution. Program Administrators may produce paper management and progress reports en masse for mailing to participants. Reports are also available online via participant specific report links and are expandable/navigable downward for a participant based on organizational report-to structure. Standard reports available include:

Management Reports:

Enrollment Report

Contains the current enrollment status of program participants by reporting structure.

Executive Summary Report

Summary of current period and program-to-date performance, earnings and issuance.

Management Summary Report

Contains current period and program-to-date performance, earnings and issuance by participant. Report renders in hierarchy order.

Discretionary Awards Summary Report

Contains summary of discretionary awards issued by participant.

Top Performer Report

Rank orders all of the individual participants in top performer rule(s) by their performance.

Manager Override Management Report

Contains the current and program-to-date override earning and issuance of all participants in a manager override rule(s).

Claim Audit Report

Contains claim status and transaction detail for all program claims selected for audit over a report-defined period.

Individual Participant Reports:

Program Progress Report

Includes individual participant performance, earnings and award issuance for each eligible rule for each cycle of the rule, as well as program totals-to-date. (Also includes rank standing in top performer rules)

Award Statement

A participant's account statement containing all deposit and redemption activities.

Manager Override Participant Report

Provides current and program-to-date override earnings and issuance to individual participant's eligible to earn in an override rule(s).

Claim Summary/Detail Report

Online report only. Includes summary information and status for all claims submitted by individual participant. Allows access to the transaction level detail within each claim.

Other Reports:

Order Report

Details award points by participant for a given order placement. Accompanies client invoice.

Performance Extract

A data extract report listing all performance data records and associated performance data fields captured.

Mailing List Report

An extract of all participants and their associated enrollment attribute data.

Objective Report

A report detailing objectives for a program (program, group and/or individual objectives).

Tax Report

Standard tax reporting available from our Award Banking System.

### APPENDIX B-2

### ADDITIONAL FEATURES OF SALES INCENTIVE MANAGER

Scope

The scope of these additional features is to enhance the Sales Incentive Manager platform to provide for the fulfillment of awards other than those offered by an award bank system (ABS).

The scope may include the following activities:

Minimize or remove current ABS specific program setup limitations.

Update awards representation to allow for fractional award issuance rather than whole units only.

Add infrastructure logic to recognize fulfillment systems and to activate proper fulfillment adapters.

Add components and controls to externalize any awards issuance to the desktop in a form that may support a non-platform-integrated fulfillment process.

Add components and controls to validate or otherwise finalize an issuance, either in bulk or with respect to particular issuance records in an interactive fashion.

Reporting award earnings both for online review and for hard copy.

Event driven e-mail notifications to online participants.

Ability for participants to provide information for the proper fulfillment of awards.

The scope may be extended to include:

implementation of adapters for particular fulfillment vendors.

further automation of award specific delivery, i.e. tracking and reporting on awarded merchandise from vendors, travel arrangements, etc.

additional cash transactions i.e. supplemental payments from participants to upgrade the awards

Product Features

Awards Fulfillment Group Configuration

The system may allow for the configuration of additional award vendor support through the establishment of Awards Fulfillment Groups. This may include the establishment of a common fulfillment group name within the system under which particular award types may be configured.

This feature may also include the linking of the fulfillment group label to an instance of a fulfillment system adapter through which all of a group's products may be issued for fulfillment.

Award Type Configuration

The system may provide a function to configure a new award type to be used in program rules or for discretionary awards.

This may include the configuration of data items required for proper fulfillment, which may result in the proper identification of required fields in the enrollment upload template.

Configure Award Types for Client Use

When appropriate, the system may allow for configuration of an award type for appropriate use by a particular client. For example, ABS awards types require proper identification of an MPIC project and ABS subproject number, each of which is unique to a particular client. Selection of an award for use within a program may cause appropriate client-specific data to be recorded.

Notify user of Award Type Data Requirements

If the user has chosen to use an award type for which data requirements are already defined, the system may support by indicating which data elements are required by the selected award types. For example, for the award types offered by ABS there are pre-defined required data elements that must be provided when submitting an order. The system may indicate these to the user on the enrollment template if an ABS award type is chosen.

Specify Multiple Award Types within a Program

The system may allow the user to indicate whether they want to use a single award type or multiple award types within a program. The system may not limit the user to a single type of award.

Manual Award Order Verification

The system may allow for the manual update of award order line item status for those items not verified automatically by the fulfillment adapter.

Create an Award Extract Report with Configurable Content and Format

For award types that do not have pre-defined data requirements the system may provide a facility for the user to define what data elements are needed and in what format they should be provided.

Event Based Email

The system may support the awards issued event regardless of the award type being issued.

Participant Earnings Report

The system may display the participant's earning activity within a program regardless of the award type being earned.

PAX-Specific Awards Configuration

The system may provide for the fulfillment of awards that require pax-entered configuration information. For example, apparel awards may require that a participant specify color, style, size, etc. This information can be entered from the pax site or the Site Coordinator site, or from a generic award configuration site.

### APPENDIX B-3

### ADDITIONAL AWARDS SUPPORT OF SALES INCENTIVE MANAGER

Background

In one embodiment, the SIM provides support only for the issuance of awards by an award banking system (ABS). When an operations manager invokes the onscreen action to execute an awards issuance, an ABS issuance job is scheduled. It does not attempt to evaluate the award type and there is no capability to execute anything than an ABS issuance.

The ABS issuance job is created with the identity of the payout bundle selected on the issuance page. The job activates the ABS bank adapter, which collects the payout summary records from the database and queues them for packaging by the ABS bank handler. The handler invokes the WS01 submission process, returning verification messages on a queue to be processed by an ABS verification job, which is scheduled to execute periodically.

The verification process is currently ABS specific, and the application does not provide for an interactive way to alter the state of an issuance. That is, if the automated verification process fails to verify a particular issuance record there is no way short of direct database manipulation to alter the state of an issuance.

Objectives

It is also contemplated that the SIM platform fulfill expectations with regard to program supported and award types offered, including an enhanced awards fulfillment aspect of the platform to allow the fulfillment of awards other than those offered by ABS.

The objectives for this embodiment are as follows:

Remove current ABS specific program setup limitations.

Add infrastructure logic to recognize fulfillment systems and to activate proper fulfillment adapters.

Add components and controls to externalize any awards issuance to the desktop in a form that may support a non-platform-integrated fulfillment process.

Add components and controls to validate or otherwise finalize an issuance, either in bulk or with respect to particular issuance records in an interactive fashion.

Approach

The approach to fulfilling these requirements will be to support the replication of the ABS banking process—creating an issuance job, executing the fulfillment asynchronously, automated reaping of verification results—for any automated fulfillment. The issuance action will recognize the award type and activate the proper fulfillment system.

For issuance of awards types with non-automated fulfillment, the operations manager will be presented a page for the selection of the output type. These types will include Excel, PDF, or XML formats. In each case the platform will schedule a job to produce the file and will place the file in the FTP repository for retrieval.

The retrieval of the output file for a non-automated fulfillment may be through the report interface, or it may be necessary to introduce a new interface specific to this retrieval.

To facilitate the verification of these issuances, the ‘Review Order’ page will be enhanced to allow the operations manager to change the state of the order as a whole, or to select individual records for status update.

To protect the integrity of the automated verification process, it may be necessary to restrict the conditions under which a manual status change may be executed.

Implementation

The implementation of this approach can be broke down into four efforts.

Refactor Program Setup Page Data Validation

The constraints on the program setup page are such that a program must have a Sub-project number and an Award Bank Type. These data items are ABS specific and are not proper validation for a program issuing to other than ABS fulfillment.

The data constraints will be properly defined and the page constraints updated appropriately.

Issuance Execution Action Refactoring

When the operations manager presses the ‘Place Order’ button on the ‘Order Program Awards’ page the ProgramOrderAwardsPlaceSaveAction class schedules the job to execute the issuance. This class will be updated to recognize the award item types in the issuance and the fulfillment vendors associated with them. It will use this information to schedule jobs to invoke the proper fulfillment adapters to execute the issuance.

A second button will be added to the calculations page to allow for the export of the issuance for alternate fulfillment. This button will move the UI to a new page that will allow for the selection of an export format and the invocation of the export preparation.

Develop Issuance Export Components

When the export option has been chosen and the export configured and initiated, an award export component will recognize the output format selected and schedule a job to create the proper file. The file will be created in the FTP repository, similar to report PDF files.

The list of prepared exports will be displayed on a page similar to the reports page and the retrieval will be similar to the template download process.

Refactor Status Change into ‘Review Order’ Page

Because issuance export has no automated verification it will be necessary to provide a means of updating the status of an order manually. This will appear on the ‘Review Order’ page as a selector at the top of the order to verify all the awards, and as a control on each order line to verify individual orders.

The business rules for when these options are available and their exact function are yet to be determined.

### APPENDIX B-4

### ATTRIBUTE USE—PLATFORM AWARDS SALES INCENTIVE MANAGER

APPENDIX B-4 describes attribute use with respect to platform awards of the sales incentive manager platform illustrated in FIG. 11.

This document describes the use of platform attributes in the creation, maintenance, and use of awards throughout the platform.

Award Setup

Attribute definitions are created and updated as award types are added or maintained.

Add Award Type

Program-specific award item attributes are stored as attributes with an AWD_ITEM_SPEC owner and a M_PROGRAM target. A qualifier with a type of AWD_ITEM_SPEC is created with the new type's SID.

Pax-specific award item attributes are stored as attributes with an AWD_ITEM_SPEC owner and a target of M_USER. A qualifier with a type of AWD_ITEM_SPEC is created with the new type's SID.

Maintain Award Type

When an award type is loaded for maintenance, program- and pax-specific award item attributes must be retrieved.

Program-specific attributes are retrieved by specifying attributes with an AWD_ITEM_SPEC owner with either no qualifiers or a qualifier with a type of AWD_ITEM_SPEC and a qualifier SID of the specific award type being maintained. The target must be M_PROGRAM.

Pax-specific attributes are retrieved by specifying attributes with an AWD_ITEM_SPEC owner with either no qualifiers or a qualifier with a type of AWD_ITEM_SPEC and a qualifier SID of the specific award type being maintained. The target must be M_USER.

Program Awards

Selecting awards for use in a program may require the configuration of attribute values for the award type and program.

Configure Program Awards

Once all award types have been selected for the program a query must be made to determine if any program-specific attributes must have values. This query retrieves all attributes with an AWD_ITEM_SPEC owner and a M_PROGRAM target, either with no qualifier or with a qualifier of the specific AWD_ITEM_SPEC SID's that have been selected. These attribute names will be displayed with an entry field with the appropriate format and content edits.

When the value is entered and the save action invoked, the page will validate the fields and store the value with the context of the program being edited.

Maintain Program Awards

The maintenance of a particular award item within a program requires a query to retrieve all attributes with an AWD_ITEM_SPEC owner and a M_PROGRAM target either with no qualifier or with a qualifier of the specific AWD_ITEM SPEC SID's that have been selected.

These attribute names will be displayed with an entry field with the appropriate format and content edits.

When the value is entered and the save action invoked, the page will validate the fields and store the value with the context of the program being edited.

Enrollment Configuration

The Create Add/Enroll Form page will display the values from the usual PROGRAM_ENROLLMENT_DEF table, but will also display any attribute with a target of M_USER with no qualifier or with a qualifier of the current CLIENT or M_PROGRAM SID.

A wards Extract

The awards extract report will retrieve values for all the required enrollment fields from PROGRAM_ENROLLMENT_DEF plus the values of any attribute with an M_USER target and an owner of AWD_ITEM_SPEC with either no qualifier or a qualifier that matches any AWD_ITEM_SPEC SID in the bundle being issued.

ABS Account Numbers

ABS account numbers returned in verification records will be stored as an attribute value. The attribute owner will be AWD_ITEM_SPEC and the qualifier will be the SID of the AWD_ITEM_SPEC record that matches the verification award type ID. The target will be M_USER and the value will be stored with a context SID of the user with the PARTICIPANT_REF_ID in the verification record.

### APPENDIX B-5

### PLATFORM ATTRIBUTES OF SALES INCENTIVE MANAGER

APPENDIX B-5 describes platform attributes of the sales incentive manager platform illustrated in FIG. 11.

Overview

Attributes describe a condition of a data entity type with respect to a particular target population, possibly for the qualification a particular instance of a data entity type.

The data entity defining the attribute values, where the condition is recognized, is referred to as the attribute ‘owner’. A ‘client’ entity may have an attribute of ‘Division’. The client may have division values of ‘HR’, ‘IT’, ‘Accounting’, and ‘Sales’. These all describe a condition within a ‘Client’ data entity.

The data entity to which an attribute value applies is the attribute ‘target’. A ‘Division’ attribute value is recognized with respect to a client's program participants. Thus, the attribute target is ‘participant’.

In this example, the attribute values are particular to a distinct instance of ‘Client’. The attribute definition would be created with a qualifier marking this as an attribute of the ‘My Big Company’ client.

Attributes may be defined against any of the standard platform entities. This includes, but is not limited to, clients, programs, hierarchy levels, volume groups, rules, users, participations, and group members. Any entity may be an attribute owner. Any entity may also be a target of an attribute, though some combinations of owner and target may not make sense because of the cardinality of the relationship between owner and target.

Attribute Definitions

Attributes are defined by a name, an owner and a target. Attribute value constraints, defining acceptable list values, data ranges, or default values, may also be part of the definition.

Name

The attribute name is a simple text value. There is no uniqueness constraint on the name. However, re-use of an attribute name may have particular consequences should a similarly named attribute be established for more than one owner type.

Owner

The attribute owner is a type of data entity selected from a list. The table below shows a candidate list of owner labels and the database table where the entities persist. Any data entity for which a distinct instance can be identified may be an attribute owner.

| Owner Entity Label | Persistence |
|---|---|
| CLIENT | CLIENT |
| PROGRAM | M_PROGRAM |
| AWARD_GROUP | AWD_FULFILLMENT_GRP |
| AWARD_CATEGORY | AWD_VEHICLE |
| AWARD_TYPE | AWD_ITEM_SPEC |
| USER | M_USER |

Target

An attribute target is the type of entity to which the value applies. As with owner, any data entity for which a distinct instance can be identified may be a target. Labels for target will be the same as for the owner.

Attribute Format

An attribute is created with a particular data format. This format is taken from type constants in the DataFormatSpec class. They include the following values.

| Name | Description |
|---|---|
| Token | An attribute that has a value of only zero or one. |
| Integer | A non-decimal number value. |
| Decimal_1 | A number value with up to one decimal place. |
| Decimal_2 | A number value with up to two decimal places. |
| Decimal_3 | A number value with up to three decimal places. |
| Decimal_4 | A number value with up to four decimal places. |
| Text | A simple text value. |

Attribute Value Configuration

Beyond a value format, the attribute has a value configuration. This indicates whether the attribute value is subject to any constraints. Such constraints are defined in the table below.

| Name | Description | Applicable Format |
|---|---|---|
| Value | No constraints. | Any |
| Range | Constrained by two bounds. | Integer, Range |
| List | One of a distinct set of | Integer, Decimal 1-4, |
| | acceptable values. | Text |

Constraint Values

The definition of an attribute may include particular data values that serve as constraints to data entered for a particular target. The attribute format may indicate the need for a constraint. The table below describes each constraint type and how it may be used.

| Name | Description | Applicable Format |
|---|---|---|
| Upper Bound | The highest value | Integer Range, |
| | acceptable. | Decimal Range |
| Lower Bound | The lowest value | Integer Range, |
| | acceptable. | Decimal Range |
| List Item | One of a distinct set of | Text List, Numeric |
| | acceptable values. | List |
| Default Value | The default value, pre- | Any |
| | selected, for the | |
| | attribute. | |

Attribute Values

Distinct attribute values are stored once in a table related both to the attribute definition and to those target instances exhibiting the attribute value.

That is, if the attribute ‘Color’ is defined for an award type of ‘Bouncy Ball’, the values ‘Red’ and ‘Blue’ are stored once in the value table. Each of those records is related to the attribute definition record. Another table stores the identifier of each user who has selected ‘Red’ and the identifier of the record indicating ‘Red’ for the attribute value. The diagram below shows the relationships involved in this attribute and its values.

[image]

Retrieving Attribute Lists

For particular platform activities, it may be necessary to retrieve a list of attributes that may be relevant to the activity. In such an instance, it may be necessary to retrieve all attributes defined as owned by a particular entity, or those with a particular target. For such purposes, it is necessary to recognize the platform context in which the attribute list is being defined.

For example, it may be appropriate to include any attribute with a target of ‘User’ in the enrollment template. The enrollment template is configured with respect to a particular program, which implies a particular client as well.

This means that any attribute that has a user target and that is not restricted to another particular client or program may be applicable to the users within this program, and should be retrieved for use in the enrollment template configuration. In this example only attribute names would be retrieved, and possibly the owner and format.

Another common example is the display of a user profile on the participant site. This page will display all regular platform user attributes, and may also display any attribute values associated with a particular user. In this instance, attribute names, values, and formats would be retrieved to build the page.

Setting an Attribute Value

The attribute for which a value is being set is identified by a name and a platform context. An attribute value is established with respect to a distinct instance of the target entity. Thus, the attributes for which values may be established are identified by the information that may be gleaned from the application page.

For example, an award item type of ‘Half-cent Points’ may have a ‘Project Number’ attribute defined for program targets. A program awards configuration page identifies a particular program, and will provide for the configuration of the ‘Half-cent Points’ award type. An entry field on the page will associate its value with an attribute named ‘Project Number’ with an owner type of ‘AWARD TYPE’ and a target of ‘PROGRAM’ and a qualifier of ‘Half-cent Points’. The value will also be associated to the particular program using the half-cent points award.

Retrieving an Attribute Value

Similar to setting an attribute, an attribute can be identified for retrieval only within the appropriate platform context.

For example, fulfillment of a ‘Half-cent Points’ order line requires the ‘Project Number’ attribute value. An order indicates an award type, a user's participation, and an award type and quantity. The participation implies a program. Thus it is possible to retrieve the project number associated with the award type and program that is required for the fulfillment.

### APPENDIX C

### Recognition Manager

### Features Overview

Maritz Incentives' Recognition Manager is functionally divided into three distinct components in support of a client's sales incentives program:

Program Administration

Program Management

Participant Communications

Each component is accessible via an Internet browser-based user interface to allow maximum flexibility in accommodating a client's program administration needs.

### Incentive Program Administration

The program administration functionality is used by Maritz Incentives (MI) to establish and administer programs operated on Maritz' Enterprise Technology Platform. Activities using this application include identification of client, project and program details, program hierarchy, establishing the program enrollment requirements, enabling pax communications and online enrollment features, and administering the Site Administrator/Pax Site Coordinator users. This is a web-based application accessed over the internet, and thereby requires no installation on the “client” machine.

### Program Creation

The software allows an MI program administrator to create an unlimited number of programs that may be activated at any time. It allows the program administrator to identify the parent-client/sub client, the account manager, the valid program dates, program award type(s) and a standard or custom theme for the program. It provides a method to capture and display the client's logo on the primary pages. For each established program, the following subset of program specifics are defined:

Hierarchy Levels and Groups

The Recognition Manager software provides for the identification of unlimited levels of hierarchy and groups in which to classify participants. Groups within a hierarchy level can be created to represent organizational alignment (e.g. districts) or to represent sales volume groups (e.g. rank dealerships on total last year's sales; create 4 volume groups, each representing one-fourth of the combined dealership volume). Levels and groups may be added and/or renamed, and can be deleted up to the point of enrollment assignment into the level/group.

Automated Group Assignment

This feature effects automatic group assignment of participants (e.g., Dealership Name, Job Title, Job Grade) based on participants' configurable enrollment attributes.

Enrollment Options

Recognition Manager provides a standard set of configurable participant enrollment attributes. The client may define up to three custom attributes and these can also be used to identify participants involved in separate incentives rules by virtue of the automated group assignment feature described above. The enrollment attributes can be indicated as required or optional data components. Minimum required enrollment fields include:

Participant ID (form label customizable. This is the key participant identifier in the system)

Hierarchy Level

Reports To

First and Last Name

Either a Mailing Address/Phone or a Business Address/Phone (when ABS award points are selected as a program award vehicle)

Additional fields include Group (necessary if designated in program hierarchy), Tax ID (necessary for tax reporting), Email Address (necessary for email communications), Job Title (label configurable), Job Grade (label configurable), Company Name (label configurable), Login ID and Password (both necessary for online participant communications). Additional fields can also be created, allowing the client to gather any type of information desired about the participants. The software supports three enrollment statuses: Enrolled, Created, Inactive. It allows for default enrollment settings including auto-enrollment. Enrollment settings may be reviewed and changed at any time by the Program Administrator.

### Incentives Awards

The Recognition Manager system supports the ability to define and enable the fulfillment of a variety of award options, including:

Award Points deposited into an award bank account

Travel

Client designated awards

E-Cards

### Incentive Program Management

Coordinator Interface

Recognition Manager utilizes a separate web site where MI Administrators and/or Client Site Coordinators enter and edit program participant enrollment data.

Enrollment

The software allows for both individual, on-line and batch enrollment of participants. The software allows the same person to participate in multiple programs for the same client and allows for the deposit of award points from multiple programs for the same client into a single account for the person. The software provides for adding and changing program enrollment status, enrollment attributes, reporting relationships and demographic information about participants.

### Participant Communications

The Recognition Manager system provides a variety of methods for communicating to participants in an incentive program including a fully configurable participant program website and automated time- and event -based e-mails.

Website

Features include:

Secure participant login/password access

Client branding

Standard theme and graphical options, as well as ability to implement client-specific theme/graphics

Three site template options, as well as ability to implement client-specific template choice

Standard site navigation includes: Home, Awards, Awards Statement, Reports, FAQs, Contact Us, Profile, and Recognition Programs pages

Content and image manageable on Home, Awards, FAQs, and Recognition Programs pages; content manageable Contact Us page; content dynamically generated on the Awards Statement, Reports and Profile pages.

Ability to add and link custom pages to the Home, Rules, Awards, FAQs, and Recognition Programs pages

Ability to enable specific targeted content views for participant audience groups on select site pages

A Gateway page can be developed and rendered to support participant access to multiple client programs and corresponding participant websites. The Gateway allows client level content management and provides individual participant access to all programs for which a participant, based on login, is enrolled.

Emails

Emails can be content-managed and can be configured to trigger based on defined events such as: awards earned, website updated, recognition received, etc. In addition, promotional, fully content manageable e-mails can be set to trigger on specific dates, and can be targeted to any program defined hierarchy level/group.

Online Enrollment

Client programs can utilize a highly configurable online enrollment functionality to support enrollment of channel partners for whom a client has incomplete data and/or who are “invited” to participate in a client program. Participants can be enrolled in a “created” status and invited to access the program url and content-manageable/client-configurable enrollment and terms and conditions pages to activate their enrollment. Participants unknown to the program database can also self-enroll when provided access to the program url and provided program specific enrollment code/enrollment ID information.

Budget Allocation

Budgets established at the client level can be further allocated to specific groups of people that are eligible to spend from the budget. When participants send recognitions, the amount of the budget allocation used is tracked.

Recognition Levels

Clients can create levels under which participants are recognized. Each level is associated with an award type, and a specified quantity of awards. For example, the first level could be for award points, another level could be for a travel award, and a third level could be for a trophy.

Recognition Programs

The client defines the recognition programs within each level under which participants can give or receive recognitions. Configuration for the recognition program includes options for specifying types and quantities of awards, which groups are eligible to give or receive recognitions, optional levels of approval, recognition program administrators, and whether or not E-Cards may be given.

Recognition Criteria

Criteria for which participants give recognitions can be specified. The criteria could correspond to a client's corporate values, for instance. When a participant recognizes someone, the participant identifies which criteria are the reasons for the recognition being given.

### Reporting

Recognition Manager offers a broad selection of standard reports to provide information concerning the recognitions given and received by participants and teams. The reports are branded with the client's logo and the chosen program theme. Some reports are presented on the screen in an HTML format, while other reports are delivered to the browser in Adobe Acrobat (PDF) format and may be printed from the browser or saved to a file for distribution. Program Administrators may produce paper management and progress reports en masse for mailing to participants. Reports are also available online via participant specific report links and are expandable/navigable downward for a participant based on organizational report-to structure. Standard reports include:

Management Reports:

Enrollment Report

Contains the current enrollment status of program participants by reporting structure.

Recognitions Given Manager's Report

Allows a manager to review all recognitions given by participants below the manager in the reporting structure.

Recognitions Received Manager's Report

Allows a manager to review all recognitions received by participants below the manager in the reporting structure.

Budget Allocation

Shows the amount used and amount remaining in each budget allocation that the manager has a right to view.

Recognition Criteria

Summarizes the quantity of awards given and received for each recognition criteria.

Individual Participant Reports:

Program Earnings

Displays the amount of awards earned by a participant.

Award Statement

A participant's account statement containing all deposit and redemption activities.

Recognitions Given

Summarizes the recognitions that the participant has given to others.

Recognitions Received

Summarizes the recognitions that the participant has received from others.

Recognitions Approval

Displays the recognitions that the participant is being requested to approve. A history of all recognitions approved or not approved by this participant can also be viewed.

Other Reports:

Order Report

Details award points by participant for a given order placement. Accompanies client invoice.

Mailing List Report

An extract of all participants and their associated enrollment attribute data.

Tax Report

Standard tax reporting available from our Award Banking System.

### APPENDIX D

### ONE EMBODIMENT OF A MULTI-TIER SOFTWARE ARCHITECTURE FOR IMPLEMENTING THE INVENTION

### INTRODUCTION

The purpose of this document is to provide an architectural overview of the Maritz Incentives Platform by presenting a number of decomposed views depicting different aspects of the architectural decisions that have been made. The decomposition intends to address two main concerns:

Most systems are too complex to understand in their entirety.

Different audiences require different perspectives.

Logical View

Most large, complex software systems should be built using an architectural structure that is based upon horizontally layered subsystems. Such structures have been proven to make a software system simpler to construct and maintain by isolating elements that are less stable (more likely to change over time) and decoupling areas of the system that address separate concerns. This decomposition pattern partitions the functionality of an application into separate layers (or tiers) that are stacked vertically. Each tier represents a level of abstraction, hiding complexity and reducing dependency of the upper tiers on a specific implementation. This is important as the system's highest tiers typically reflect the application functionality as specified in the use cases whereas lower tiers typically focus on implementation of reusable domain components and integration with enterprise resources. In a layered architecture, each tier interacts only with objects in the same tier and with objects in the tier directly below it. Failure to restrict dependencies in this way causes architectural degradation and makes the system brittle and difficult to maintain. However, this can have consequences on performance as calls must be propagated through several tiers. And extensibility could suffer if contracts between the tiers are not robust enough to handle future requirements. But adherence to such “strict” layering permits greater latitude when deploying the application to physically distribute the layers, use the domain layer across applications, and more easily configure integration to enterprise resources such as databases, directories, and transaction systems.

It is important to note that logical layers describe the separation of a system into potentially distributable parts. While the number of architectural layers, divisions of responsibility, and choice of technologies, will influence the deployment topology, the tiers do not imply any particular physical distribution. This will be addressed in a separate architectural view.

The strategy that has been applied is responsibility-based. Each tier encapsulates a distinct set of responsibilities that should be unambiguous and non-overlapping with those of other tiers. Within and between the tiers, additional design and implementation patterns have been identified. It should be possible to clearly allocate implementation artifacts (components, classes, HTML pages, etc.) into a single responsibility layer.

[image]

client Tier

The client tier represents devices or applications that access the system. Examples would include a web browser, Java application, native application, applet, mobile device, or another system acting as a value added retailer (VAR). Clients that empower human users in a B2C scenario have responsibility for layout and rendering of the UI presentation, accepting and validating user input, and mapping user gestures such as key presses and mouse clicks to presentation events that it communicates to the web server for interpretation by the presentation tier. Clients in a B2B scenario are responsible for transforming data streams to/from that provided by the native system on behalf of which they are mediating into data streams that can be processed by the service provider—our system. Clients should remain relatively isolated from the rest of the system; they do not implement business logic or directly contact the system's enterprise resources.

For this development we will focus on one type of B2C client—HTML clients, specifically web browsers. HTTP/s will be the transport technology for delivering HTML, CSS, and JavaScript streams to the browser and for accepting requests. To the extent that it is used, client-side script should focus on enhancing navigation, performing syntactic validation, and handling simple errors. Script logic should be confined to simple limited actions that do not require the rendering of new content (“page switch”). Syntactic validations include checks on individual fields of an input form. For example, is the entry a minimum length? Is it alpha or numeric? Does it have the right format for a date, phone number or social security number? These simple types of syntactic validations should be done on the client, as this will improve performance and scalability by reducing the number of network interactions between the client and the application server.

We will also provide services that permit communication with B2B clients. This implementation will be done using a web services style of delivery. That is, it will use technologies such as XML and SOAP that are compatible with web services but we will not immediately implement dynamic discovery through UDDI. The long term goal is to open the platform to external vendors and integrators to configure and execute performance improvement programs through XML messaging.

Presentation Tier

The presentation tier intercepts and services client tier requests. It integrates with security services to assure sign-on authentication and authorization, maintains the conversational state of the application, performs more complex syntactic validation, selects and executes appropriate application logic, constructs the response, and delivers the response to the client. This wide range of responsibilities will be distributed across a variety of components. In fact, the presentation tier can be considered to have a “mini-architecture” of its own. The components of this “mini-architecture” include WebSphere's web-app deployment environment, Jakarta Struts, and Enhydra XMLC.

The presentation tier can be viewed as a set of discrete user interfaces providing various views on a common underlying system. Some of these interfaces are internet accessible and some intranet accessible.

[image]

All means of user interaction with the system should be secured. When configured as separate web applications, authentication and authorization policies can be determined individually. WebSphere Application Server provides the means to administer security for web applications by specifying the authentication method and mechanism. Execution of the security policy at run-time can use a directory server. The specifics of this are discussed in Services View—Authentication. The presentation tier's responsibility is to define the necessary web resources (servlets and HTML forms) that are then used by the administrator to define the security policy.

Struts is an open source framework from the Jakarta project of the Apache Software Foundation for building web applications using Java servlet and JSP technology. The framework encourages construction of web applications based on a Model-View-Controller paradigm, the most commonly recommended architectural design pattern for interactive applications. A design team applying the MVC pattern to an interactive application splits the implementation into three cooperating modules: the model representing application data and business logic, the views that provide data presentation and user input, and a controller to dispatch requests and control flow. Most web application frameworks use some variation of the MVC design pattern. Complex syntactic validations involve multiple fields or begin to incorporate business process policies. For example, is the start date less than the end date? Does the date requested fall on a weekend or holiday?

An important design consideration for the presentation tier was the separation of page markup and programming logic which are essential to the delivery of web applications. Common presentation technologies such as JSP and ASP encourage the mingling of markup and logic. This results in pages that are difficult to read and more costly to maintain. In addition, Java programmers and HTML writers often find the need to modify the same set of pages at the same time. When code and formatting is encapsulated in the same artifact, this results in delays as one team waits for the other to finish, or “lost changes” as both teams submit differing versions of the same files.

From the available solutions to these problems we have chosen to use XMLC (XML Compiler), an open source project from Enhydra. XMLC is a Java-based compiler that takes a document written in HTML or XML and creates Java classes that will faithfully recreate the original document. The resulting Java classes can be used to insert dynamic content into the document framework at run time. XMLC generates access methods for document tags that have HTML ID and Class attributes associated with them. This makes it possible for the Java programmer to manipulate the contents of the page with little or no concern for the structure or layout of the page. It also provides for compile time checking for changes in a page that will affect the code that generates dynamic content. Throughout the development process, a collection of documents can remain a valid mockup of the application. Changes to the layout of a page can often be made without modifying the code that uses it so that page designers and Java developers can work in parallel. Finally, XMLC permits everyone to continue using familiar and more efficient technologies and tools. Selection of an alternate like XML/XSLT would require retooling, training, additional infrastructure

Application Tier

This tier serves as a mediation layer between the presentation tier and domain tier. It captures application-specific use case functionality, mapping presentation tier requests to some series of domain tier requests. In the context of servlet-based applications, objects in the application tier (also known as Mediators or Commands) provide a convenient and consistent way to transfer application state between presentation elements. Still, they should maintain independence from the user interface by not containing any references to presentation objects, including session, request and response objects. Since they are application-specific and possess intimate knowledge of the domain for which they are mediating, they can reference the public state and behavior exposed by the domain tier. The application tier will be implemented as Command objects that can be instantiated, parameterized, and executed to perform their encapsulated function that should be defined to satisfy a specific application user interface request or use case. IBM provides a Command Framework infrastructure for WebSphere that simplifies the development of command objects. There are two major problems that the Command Framework attempts to address.

One problem is performance. The granularity of artifacts on the server (such as, objects, tables, procedure calls, files, etc.) often causes a single client-initiated business logic request to involve several round-trip messages between the client and server. This might entail extra calls to perform the business task and then impose additional calls to retrieve the results of that task. If the client and target server are not in the same Java Virtual Machine (JVM), these calls go between processes and are, therefore, expensive in terms of computer resources.

If the calls must go over a network, they are even more costly. To prevent unnecessary delays and improve application performance, it is advantageous to perform a business task in as few interactions between the client and server sides as is natural to the task. The Command Framework provides for server-side execution of command objects resulting reduction of round trips between the client and EJB container and also providing for transactional behavior without necessitating client-managed JTA transactions.

Another problem is that there are several possible styles for how business logic can be implemented, including Enterprise JavaBeans (EJB), JDBC direct database access, JDBC access to stored procedures, the Common Connector Framework, file system access, etc. In addition to different implementation programming models, each of these styles has a different way to invoke a request to execute business logic. Because the Command Framework is generic and extensible, it can hide these different server invocation mechanisms behind a simple and uniform mechanism thereby simplifying presentation development.

Domain Tier

This tier models the abstractions in the problem domain. Objects in this tier encapsulate the business rules and semantics of these abstractions independent of the specific application being constructed. That is to say, the behavior implemented by domain objects is thought to be useful in any context in which the abstraction is used, not just in the context of the use cases for a single application. This is an important point as the domain objects must support two similar but differentiated applications—the PRS public do-it-yourself site and the Maritz Incentives VAR site.

Semantic validations that require access to process logic and data occur here. For example, is an order or product number valid? Will the change in quantity make the resulting line item quantity less than zero? Is the requested price within 10 percent of the current average? In addition to these data consistency validations, domain objects enforce constraints on cardinality of relationships with other domain objects.

Within the domain tier, business logic and services will be allocated among identified components or subsystems.

The domain tier will be implemented using Java classes as component facades, and business processes, EJB Entity Beans for transactional persistence, Data Access Objects for query, and Value Objects for coarse-grained distribution of domain object state. The interface to the domain tier is comprised of the EJB Session Beans and Value Objects. Clients should not directly access EJB Entity Beans nor should they directly use Data Access Objects.

Integration Tier

The integration tier is responsible for communicating with external resources and systems, such as data stores and legacy applications. The domain tier is coupled to it to the extent that it will use services of the integration tier whenever it requires data or services of the resource tier. The components in this tier might use JDBC, J2EE Connectors, JMS, or other such middleware to work with the resource tier.

Resource Tier

This is the tier that contains data and external resources such as legacy systems, databases, credit card authorization services, fulfillment vendors, point banks, etc.

Impact on Development

Our development activities will focus on the Presentation, Application, and Domain tiers. The Client tier is essentially the browser. The HTML, CSS, and JavaScript required by the Client tier are technically Presentation tier artifacts. Likewise, the Resource tier is essentially existing systems like 1FS, e-ABS, and NAS, and infrastructure components such as Oracle, MQSeries, and SecureWay Directory. We won't be developing these. There may be Integration tier effort to develop or enhance the components that abstract the Resource tier. But to the extent that such integration components already exist, this activity should be a minor part of the overall effort.

Services View

Defines important architectural mechanisms and how they will be realized in the design and implementation.

Authentication

Authentication is the process of determining that a user (or process) really is who they claim to be. This is usually done with some sort of user ID/password lookup scheme or a certificate. WebSphere Application Server provides for several challenge mechanisms to retrieve credentials and several options for authenticating using the provided credentials. The Incentives Platform will use a custom login form when requesting user input for authentication. The Incentives Platform database will serve as a “custom registry” to WebSphere for performing authentication and mapping of users to supported roles.

Authorization

Authorization is the process of determining if a user has rights to use a secured resource in some way. For example, the right to invoke a method on an EJB, execute a command, or access a particular HTML page, servlet or JSP. At present, authorization needs have been limited to role-based enablement, the primary roles being that of VAR, someone that can create and configure programs, and Site Coordinator, someone that can administer programs. As additional requirements arise, the number of supported roles will change and greater depth to authorization capabilities will be implemented.

Concurrency

When multiple users attempt to modify the same information at the same time, concurrency issues may arise. Initial analysis indicates that this will not be a typical usage scenario for the system. If two users attempt to modify the same data at the same time, the last modification will be the value recorded by the system.

Identity

Each entity requires a unique identity. The persistence layer requires that an identity be assigned to each entity that is stored. The Incentives Platform has an ID Generator that provides a unique identity for each entity. All entities are assigned IDs from the same “namespace”. No two entities will have the same identifier. The design chosen ensures performance, integrity, and scalability concerns will be addressed.

Logging

During the execution of an application, various events of interest, from the routine to the critical, arise. The operations and development teams need to review these events to determine whether the system is operating correctly, gather performance statistics, and investigate the cause of defects. The Incentives Platform provides a mechanism for capturing such events and recording them in a consistent format to a disk-based log that may be reviewed by authorized personnel. Information of a sensitive nature, e.g., credit card numbers, will not written to the log.

Messaging

Asynchronous communication within the application permits potentially long-running operations, such as batch file processing and report generation, to be decoupled from the user interface. Messaging also provides a clean interface for injecting into the application events that arise from legacy system integration. A durable and reliable messaging infrastructure is required to ensure that such events are recorded and delivered. WebSphere MQ will be used as the messaging transport mechanism.

Naming

In a distributed environment, components may be deployed across the enterprise on different physical systems. Finding these components and binding to them for distributed communication requires a naming service. WebSphere implements a JNDI-compliant naming service that will be used for this purpose.

Persistence

Persistence refers to the ability of a business entity to exist beyond the lifetime of the application. Typically this involves writing the entity's contents to a database or some other storage facility so that it can be retrieved at a later date. The Incentives Platform will use Oracle 8i as the persistence resource. Above this, an application layer that provides services for persistence will be used by the application to abstract it from the details of SQL and JDBC. This layer will be automatically generated, for the most part, from the database schema as it evolves.

Time and Calendar

There are currently no business requirements under implementation that require job scheduling. When the need arises, the development team will evaluate the available options and build or buy an appropriate job scheduling implementation.

Transaction Management

Proper transaction management is crucial to the integrity and performance of an enterprise application. WebSphere Application Server provides a robust transaction management facility that ensures ACID properties across the resources enlisted in a transaction. The Incentives Platform delegates transactional control to the WebSphere container for transaction management. WebSphere resource managers are used to acquire access to transactional resources in the context of an EJB to ensure correct transaction management is automatically performed by the container.

Component View

The domain tier of the architecture will be component-based Cohesive areas of the system that address a particular group of tightly coupled entities focused on a common domain concern will be assembled as a component with a facade that will serve to present a unified view of the services and capabilities offered by the component.

Member

A Member is a person or organizational entity known to the system. All users are registered as members. VAR and Client organizations are also registered as members. Clients may be arranged in parent-child relationships to represent sub-organizations within a Client. Address information can be stored for each registered members. The component associates members with roles for authentication and authorization purposes. And multiple point bank account numbers may be stored for each member.

Program

The Program component encompasses the high-level definition of an incentive program. The root entity is, of course, Program. Group defines program-specific targeted subsets of the participant population such as hierarchy levels and volume groups. Enrollment Definition represents the configuration of a template used to collect participant information during enrollment.

Participation

Participation represents the relationship of a Member with a Program. This component records the Participation Status, Reporting Assignment, and Group Assignments with a history of how these have changed over time.

Payout

This component represents the entities that define how the targeted participant populations will be rewarded and the mechanisms for assessing performance and issuing awards. Metric defines an activity that is to be measured. Performance Claim represents the details of a participant's progress against a Metric. An Objective is a performance goal to be achieved in a specific Metric. Award Vehicles define the things that a participant might be awarded by a Program. Payout Rule brings these concepts together to define how to reward participants in a specified Group based on their achievement against an Objective as reported by Performance Claims submitted against a specific Metric. This component also captures the Payout Awards that have been issued and their status through the approval and order business processes.

Theme

A Theme is a named collection of graphics and other resources intended to inspire and motivate participants through a consistent, cohesive message throughout on-line and print communications.

Reporting

Reporting is a technical component that provides an infrastructure for generation of reports. All reports are currently generated in PDF. Report requests are handled asynchronously to permit report generation activities to be managed so as not to impact the performance of on-line activities and to prevent browser timeouts resulting from long-running report generation requests.

Batch

Batch is a technical component that provides the mechanism necessary for requesting asynchronous handling of large input operations such as enrollment, objective, and performance claim processing. The component records the status of submitted jobs and associated problems.

Deployment View

Identifies how developed components will be distributed across physical nodes in the deployment environment.

Pattern Catalog

This catalog provides additional information on the various patterns that have been mentioned in this document. A design pattern describes a proven solution to a recurring design problem, placing particular emphasis on the context and forces surrounding the problem, and the consequences and impact of the solution. Only when all these elements have been considered and weighed can a decision be made as to whether the pattern represents an effective solution. Use of patterns is no guarantee of success. But use of patterns is a best practice given that they are proven solutions that can be directly reused or adapted to fit a design scenario. Patterns also form a vocabulary by which designers and developers can communicate ideas and designs. These patterns are not original inventions. They have been in various resources including the Sun J2EE BluePrints, the book EJB Design Patterns, and Core J2EE Patterns.

| Pattern | Intent |
|---|---|
| Layered | Maximize reusability, extensibility, scalability, and |
| Architecture | portability while reducing coupling by partitioning a |
| | system into logically separate layers. |
| Command | Encapsulate a request as an object, thereby letting you |
| | parameterize clients with different requests, queue or log |
| | requests, and support undoable operations. |
| Data Access | Decouple business logic from data access logic and |
| Object | adapt the resource being accessed so that the type |
| | of resource can change easily and independently. |
| Front | Centralize view management (navigation, templating, |
| Controller | security, etc.) for a Web application in a single |
| | object that handles incoming client requests. |
| Model-View- | Facilitate maintenance, extensibility, flexibility, and |
| Controller | encapsulation by decoupling software layers from one |
| | another. |
| Value | Efficiently transfer remote, fine-grained data by |
| Object | sending a coarse-grained view of the data. |
| Value Object | Construct a composite view of data from different |
| Assembler | business components to reduce coupling of clients to |
| | the model implementation, separate business logic from |
| | the client tier, and improve network and transaction |
| | performance. |
| Service | Enable business component services to be activated |
| Activator | asynchronously by requesting those services through |
| | messaging. |

What is claimed is:

1. A system comprising:
a resource of programs;
a platform operated by a system developer for providing
access to the resource of programs;
an administrative interface for use by an administrator for interfacing with the platform, the administrative interface for permitting the administrator to:
access the programs via the platform,
select for the client a particular program from the accessed programs,
configure the selected, particular program of the client, and
track the configured program of the client;
a site coordinator interface for use by a site coordinator for interfacing with the platform, the site coordinator interface for permitting the site coordinator to:
access the particular program via the platform, and
support the particular program of the client; and
a participant interface for use by participants of the particular program for interfacing with the platform, the participant interface for permitting each participant of the particular program to:
access the particular program via the platform, and
review information relating to the accessed, particular program.

2. The system of claim 1 wherein the site coordinator interface permits the site coordinator to administrate the particular program, track progress of the particular program, issue discretionary awards for the particular program, export data from the particular program, calculate awards relating to the particular program and fulfill orders of the particular program.

3. The system of claim 1 including three distinct web sites, one for implementing each of the administrative interface, the site coordinator interface and the participant interface.

4. The system of claim 1 wherein capabilities provided by the participant interface include award information and award requests.

5. The system of claim 1 further comprising a “do-it-yourself” interface permitting clients to access the platform to set up additional programs or supplemental programs.

6. The system of claim 1 wherein the administrative interface permits the administrator to perform one or more of the following with regard to program configuration: setting up a program, maintaining information of a program, maintaining a contact list of a program, maintaining a site coordinator list of a program, maintaining a product list of a program, defining hierarchy of participants of a program, controlling hierarchy of participants of a program, selecting payout rules of a program, maintaining payout rules of a program, specifying top performer rules of a program, maintaining top performer rules of a program, maintaining a multiplier list of a program, maintaining an enrollment template of a program, maintaining a performance template of a program, revising a program, activating a program, deactivating a program, selecting an reward, defining an reward, defining attributes of an reward and/or consolidating accounts of two or more programs, consolidating two or more program accounts of a participant.

7. The system of claim 1 wherein rewards may take any form and wherein the administrative interface permits the administrator to designate various rewards to be used with the same program and/or to designate a particular reward to be used within different programs.

8. The system of claim 1 wherein rewards may take any form and wherein the administrative interface permits the administrator to designate each reward and its attributes and/or to designate which attributes are to be associated with a particular participant.

9. The system of claim 1 wherein rewards may take any form and wherein the administrative interface permits the administrator to designate each reward and its attributes and/or to designate which attributes are to be associated with a performance parameter.

10. The system of claim 1 wherein the client or the administrator may consolidate client accounts of two or more programs of the client or consolidate participant accounts of two or more programs in which the participant is enrolled.

11. The system of claim 1 wherein a client or administrator creating a program is directed to creating a participant website for facilitating communication with each participant.

12. The system of claim 11 wherein creating a participant website comprises selecting from a plurality of templates and selecting from various libraries artwork and other details to plug into the selected website template.

13. The system of claim 1 wherein an administrator is permitted to define a hierarchical group of participants and is permitted to define a rule applies to a selected group of participants wherein the hierarchical and selected groups are different.

14. The system of claim 1 wherein an administrator is permitted to define a hierarchical group of participants of a program according to geographical location so that the hierarchy is defined by location.

15. The system of claim 1 further comprising an enrollment template including participant information which is downloaded from the platform for population of the participant information and which is uploaded to the program for transferring the participant information from the template to the program.

16. The system of claim 1 wherein the administrative interface permits the administrator to perform one or more of the following with regard to program tracking: track usage of a program, track undelivered email of a program, track earned points of a program, track issued points of a program, and/or track activity of a program.

17. The system of claim 1 wherein the site coordinator interface permits the site coordinator to perform one or more of the following with regard to program support: conduct program administration of a program, track progress of a program, manage discretionary awards of a program, export data of a program, calculate awards of a program, and/or fulfill orders of a program.

18. The system of claim 1 wherein the site coordinator interface permits the site coordinator to perform one or more of the following with regard to program administration: maintain organization of a program, enroll participants of a program, add performance data of a program, revise performance data of a program, audit performance data of a program, release awards of a program, maintain participant data, activate one or more participants of a program, and/or inactivate one or more participants of a program.

19. The system of claim 1 wherein the site coordinator interface permits the site coordinator to perform one or more of the following with regard to progress tracking: generate enrollment reports of a program, generate progress reports of participants of a program, generate account history reports of a program, generate management information reports of a program, generate top performer reports of a program, generate performance listings of a program, generate issuance reports of a program, generate trouble shooting reports of a program, and/or generate a user guide of a program.

20. The system of claim 1 wherein the site coordinator interface permits the site coordinator to perform one or more of the following with regard to discretionary awards: managing half penny points, managing 25 dollar points, managing individual travel awards, managing branded cards and/or managing group travel.

21. The system of claim 1 wherein the site coordinator interface permits the site coordinator to perform one or more of the following with regard to data exporting: print labels of a program, export mail of a program, export analysis data of a program, export tax data of a program, download enrollment templates of a program, and/or download performance templates of a program.

22. The system of claim 1 wherein the site coordinator interface permits the site coordinator to perform one or more of the following with regard to award calculation: calculate performance payout of a program, calculate manager override payout of a program, and/or calculate top performer payout of a program.

23. The system of claim 1 wherein the site coordinator interface permits the site coordinator to perform one or more of the following with regard to order fulfillment: deposit points of a program, order items of a program, generate emails regarding group travel of a program, record orders of a program, and/or purchase awards of a program.

24. The system of claim 1 wherein the participant interface permits the participant to perform one or more of the following with regard to the access of program information: review all programs of which the participant is involved, review program home pages of programs of which the participant is involved, review program rules of programs of which the participant is involved, review program awards of programs of which the participant is involved, review the participant's progress of programs of which the participant is involved, review account history of programs of which the participant is involved, review terms and conditions of programs of which the participant is involved, maintain participant data of the participant of programs of which the participant is involved and/or completing survey as a performance subject to reward.

25. A method for use with a resource of programs comprising:
providing access to the resource of programs;
permitting an administrator to:
access the programs,
select for a client a particular program from the accessed programs,
configure the selected, particular program of the client, and
track the configured program of the client;
permitting a site coordinator to:
access the particular program, and
support the particular program of the client; and
permitting each participant of a particular program to:
access the particular program, and
review information relating to the accessed, particular program.

26. The method of claim 25 wherein the site coordinator is permitted to administrate the particular program, track progress of the particular program, issue discretionary awards for the particular program, export data from the particular program, calculate awards relating to the particular program and fulfill orders of the particular program.

27. The method of claim 25 wherein each participant is permitted to receive award information and request award.

28. The method of claim 25 wherein the client is permitted to access the platform to set up additional programs or supplemental programs.

29. The method of claim 25 wherein the administrator is permitted to perform one or more of the following with regard to configuring the selected, particular program of the client: setting up a program, maintaining information of a program, maintaining a contact list of a program, maintaining a site coordinator list of a program, maintaining a product list of a program, defining hierarchy of participants of a program, controlling hierarchy of participants of a program, selecting payout rules of a program, maintaining payout rules of a program, specifying top performer rules of a program, maintaining top performer rules of a program, maintaining a multiplier list of a program, maintaining an enrollment template of a program, maintaining a performance template of a program, revising a program, activating a program, deactivating a program, selecting an reward, defining an reward, defining attributes of an reward and/or consolidating accounts of two or more programs, consolidating two or more program accounts of a participant.

30. The method of claim 25 wherein rewards may take any form and wherein the administrator is permitted to designate various rewards to be used with the same program and/or to designate a particular reward to be used within different programs.

31. The method of claim 25 wherein rewards may take any form and wherein the administrator is permitted to designate each reward and its attributes and/or to designate which attributes are to be associated with a particular participant.

32. The method of claim 25 wherein rewards may take any form and wherein the administrator is permitted to designate each reward and its attributes and/or to designate which attributes are to be associated with a performance parameter.

33. The method of claim 25 wherein the client or the administrator is permitted consolidate client accounts of two or more programs of the client or consolidate participant accounts of two or more programs in which the participant is enrolled.

34. The method of claim 25 wherein a client or administrator creating a program is directed to create a participant website for facilitating communication with each participant.

35. The method of claim 34 wherein creating a participant website comprises selecting from a plurality of templates and selecting from various libraries artwork and other details to plug into the selected website template.

36. The method of claim 25 wherein an administrator is permitted to define a hierarchical group of participants and is permitted to define a rule applies to a selected group of participants wherein the hierarchical and selected groups are different.

37. The method of claim 25 wherein an administrator is permitted to define a hierarchical group of participants of a-program according to geographical location so that the hierarchy is defined by location.

38. The method of claim 25 further comprising an enrollment template including participant information which is downloaded from the platform for population of the participant information and which is uploaded to the program for transferring the participant information from the template to the program.

39. The method of claim 25 wherein the administrative interface permits the administrator to perform one or more of the following with regard to program tracking: track usage of a program, track undelivered email of a program, track earned points of a program, track issued points of a program, and/or track activity of a program.

40. The method of claim 25 wherein the site coordinator is permitted to perform one or more of the following with regard to program support: conduct program administration of a program, track progress of a program, manage discretionary awards of a program, export data of a program, calculate awards of a program, and/or fulfill orders of a program.

41. The method of claim 25 wherein the site coordinator is permitted to perform one or more of the following with regard to program administration: maintain organization of a program, enroll participants of a program, add performance data of a program, revise performance data of a program, audit performance data of a program, release awards of a program, maintain participant data, activate one or more participants of a program, and/or inactivate one or more participants of a program.

42. The method of claim 25 wherein the site coordinator is permitted to perform one or more of the following with regard to progress tracking: generate enrollment reports of a program, generate progress reports of participants of a program, generate account history reports of a program, generate management information reports of a program, generate top performer reports of a program, generate performance listings of a program, generate issuance reports of a program, generate trouble shooting reports of a program, and/or generate a user guide of a program.

43. The method of claim 25 wherein the site coordinator is permitted to perform one or more of the following with regard to discretionary awards: managing half penny points, managing 25 dollar points, managing individual travel awards, managing branded cards and/or managing group travel.

44. The method of claim 25 wherein the site coordinator is permitted to perform one or more of the following with regard to data exporting: print labels of a program, export mail of a program, export analysis data of a program, export tax data of a program, download enrollment templates of a program, and/or download performance templates of a program.

45. The method of claim 25 wherein the site coordinator is permitted to perform one or more of the following with regard to award calculation: calculate performance payout of a program, calculate manager override payout of a program, and/or calculate top performer payout of a program.

46. The method of claim 25 wherein the site coordinator interface permits the site coordinator to perform one or more of the following with regard to order fulfillment: deposit points of a program, order items of a program, generate emails regarding group travel of a program, record orders of a program, and/or purchase awards of a program.

47. The method of claim 25 wherein the participant is permitted to perform one or more of the following with regard to the access of program information: review all programs of which the participant is involved, review program home pages of programs of which the participant is involved, review program rules of programs of which the participant is involved, review program awards of programs of which the participant is involved, review the participant's progress of programs of which the participant is involved, review account history of programs of which the participant is involved, review terms and conditions of programs of which the participant is involved, maintain participant data of the participant of programs of which the participant is involved and/or completing survey as a performance subject to reward.

48. A method of doing business for selling programs comprising:
providing a platform for accessing programs (such as available via resource);
contracting with a VAR to configure and track via the platform the programs for clients of the VAR;
authorizing a site coordinator to administer and track via the platform progress of the programs; and
permitting participants via the platform to review their program and award information.

49. The method of claim 48 wherein the VAR is responsible for payment to the system developer for programs of their clients.

50. The method of claim 48 wherein the system developer will pay commissions on the sale of program awards through the VAR's programs.

51. In a system for providing a platform including a resource of programs including rewards for participants of the programs, the improvement comprising an interface which permits an administrator to designate various rewards to be used with the same program and/or to designate a particular reward to be used within different programs.

52. The system of claim 51 wherein rewards may take any form and wherein the interface permits the administrator to designate each reward and its attributes and/or to designate which attributes are to be associated with a particular participant.

53. The system of claim 51 wherein rewards may take any form and wherein the interface permits the administrator to designate each reward and its attributes and/or to designate which attributes are to be associated with a performance parameter.

54. In a system for providing a platform including a resource of programs of clients including rewards for participants of the programs, the improvement comprising an interface which permits the client or its administrator to consolidate client accounts of two or more programs of the client or consolidate participant accounts of two or more programs in which the participant is enrolled.

55. In a system for providing a platform including a resource of programs of clients including rewards for participants of the programs, the improvement comprising an interface which permits the client or its administrator to define a hierarchical group of participants and is permitted to define a rule applying to a selected group of participants wherein the hierarchical and selected groups are different.

56. The system of claim 55 wherein an administrator is permitted to define a hierarchical group of participants of a program according to geographical location so that the hierarchy is defined by location.

57. In a system for providing a platform including a resource of programs of clients including rewards for participants of the programs, the improvement comprising an enrollment template including participant information which template is downloaded from a platform of the program for population of the participant information and which template is uploaded to the program for transferring the participant information from the template to the program.

58. The system of claim 57 wherein the participant information includes tenure and wherein tenure of each participant is tracked by the program so that automated rewards as designated by a rule of a rules engine are issued.

59. The system of claim 57 wherein the platform is award neutral and is linked to a third party award issuer for providing awards to participants.

60. The system of claim 59 wherein awards representations include a fractional award issuance to accommodate various types of award issuance.

61. In a system for providing a platform including a resource of programs of clients including rewards for participants of the programs, the improvement comprising said platform being award neutral and linked to a third party award issuer for providing awards to participants..

62. The system of claim 61 wherein awards representations include a fractional award issuance to accommodate various types of award issuance.

63. A system comprising:
a resource of programs;
a platform operated by a system developer for providing access to the resource of programs;
an administrative interface for use by an administrator for interfacing with the platform, the administrative interface for permitting the administrator to maintain the programs via the platform;
a manager interface for use by a site coordinator for interfacing with the platform, the site coordinator interface for permitting the site coordinator to access the particular program via the platform, and manage the particular program of the client; and
a participant interface for use by participants and for use by participant site administrators of the particular program for interfacing with the platform, the participant interface for permitting each participant of the particular program to access the particular program via the platform, and the participant interface for permitting each participant site administrator to maintain and administer the program.

64. The system of claim 63 wherein the administrative interface permits the administrator to perform one or more of the following with regard to maintaining the programs: Award Maintenance, Award Group Maintenance, Award Type Maintenance, Client Maintenance, Client Attribute Maintenance, Client Budget Maintenance, Client Demographic Maintenance, Implicit Group Maintenance, Client Program Maintenance, Client Program Hierarchy Maintenance, Client Program Enrollment, Online Enrollment Configuration, Product Metric Maintenance, Online Claim Maintenance, Program Payout Rule Maintenance, Program Objectives Maintenance, Audit Participant Activity, Program Award Calculations, Program Award Issuance Orders, Program Report Selection & View, Enable Participant On-line Communications, Enable Event-Driven email Communications, and/or Enable Time-Driven email Communications.

65. The system of claim 63 wherein the manager interface permits the site coordinator to perform one or more of the following with regard to managing the programs: Maintain Participant Demographics, Inquire Participant Performance, Inquire Participant Objectives, Inquire Participant Awards Issued, Submit Single Participant Enrollment, Submit Participant Enrollment Batch, Submit Participant Objectives Batch, Submit Single Participant Performance, Submit Batch Participant Enrollments, Search Participants, Review performance submissions, and/or Issue Discretionary Awards.

66. The system of claim 63 wherein the participant interface permits the participant to perform one or more of the following with regard to accessing the programs: View Gateway, View Program Homepage, View Program FAQs, View Program Rules, View/Submit Contact Us email, View Organization; Select & View Reports, Recognize Someone, View Award Account Statement, View Recognition Programs, and/or Submit Performance Claim.

67. The system of claim 63 further comprising an operational interface for permitting a participant site administrator of a particular program to maintain and administer the particular program

68. The system of claim 67 wherein the operational interface permits the participant site administrator to perform one or more of the following with regard to maintaining and administering the particular program: Client Logo Maintenance, Main Navigation Maintenance, Pax Site Style Maintenance, Administrator Permissions Maintenance, Custom Page Administration, Participant Content Group Maintenance, Participant Report Privilege Maintenance, Batch Participant Enrollment, Recognition Level Maintenance, Survey Maintenance, Content Management Maintenance, Home Page Maintenance, Rules Page Maintenance Award Page Maintenance, FAQ Page Maintenance, Contact Us Maintenance, Image Library Maintenance, Group Membership Maintenance, Email (time driven) Content Maintenance, Email (event driven) Content Maintenance, Program Report Selection & View, Recognition Program Maintenance, and/or Approve/Audit Performance Claim.

69. The system of claim 67 including four distinct web sites, one for implementing each of the administrative interface, the manager interface, the participant interface and the operational interface.

70. The system of claim 63 including three distinct web sites, one for implementing each of the administrative interface, the manager interface and the participant interface.

71. The system of claim 63 wherein capabilities provided by the participant interface include award information and award requests.

72. The system of claim 63 further comprising a “do-it-yourself” interface permitting clients to access the platform to set up additional programs or supplemental programs.

73. The system of claim 63 wherein the participant interface is linked to other award sites for fulfilling participant awards.

74. A method for use with a resource of programs comprising:
providing access to the resource of programs; permitting an administrator to maintain the programs via the platform;
permitting a site coordinator to access the particular program via the platform, and manage the particular program of the client; and
permitting each participant of the particular program to access the particular program via the platform, and
permitting each participant site administrator to maintain and administer the program.

75. A system comprising:
a resource of programs;
a platform operated by a system developer for providing access to the resource of programs;
an administrative interface for use by an administrator for interfacing with the platform, the administrative interface for permitting the administrator to maintain the programs via the platform;
a operational interface for use by a participant site coordinator for interfacing with the platform, the operational interface for permitting the participant site coordinator to access the particular program via the platform, and maintain and administer the particular program of the client; and
a participant interface for use by participants for interfacing with the platform, the participant interface for permitting each participant of the particular program to access the particular program via the platform.

76. The system of claim 75 wherein the administrative interface permits the administrator to perform one or more of the following with regard to maintaining the programs: Award Maintenance, Award Group Maintenance, Award Type Maintenance, Client Maintenance, Client Attribute Maintenance, Client Budget Maintenance, Client Demographic Maintenance, Implicit Group Maintenance, Client Program Maintenance, Client Program Hierarchy Maintenance, Client Program Enrollment, Online Enrollment Configuration, Product Metric Maintenance, Online Claim Maintenance, Program Payout Rule Maintenance, Program Objectives Maintenance, Audit Participant Activity, Program Award Calculations, Program Award Issuance Orders, Program Report Selection & View, Enable Participant On-line Communications, Enable Event-Driven email Communications, and/or Enable Time-Driven email Communications..

77. The system of claim 75 wherein the operational interface permits the participant site coordinator to perform one or more of the following with regard to maintaining and administering the programs: Client Logo Maintenance, Main Navigation Maintenance, Pax Site Style Maintenance, Administrator Permissions Maintenance, Custom Page Administration, Participant Content Group Maintenance, Participant Report Privilege Maintenance, Review performance submissions, Recognition Level Maintenance, Survey Maintenance, Content Management Maintenance, Home Page Maintenance, Rules Page Maintenance, Award Page Maintenance, FAQ Page Maintenance, Contact Us Page Maintenance, Image Library Maintenance, Group Membership Maintenance, Email (time driven) Content Maintenance, Email (event driven) Content Maintenance, Program Report Selection & View, Recognition Program Maintenance, Approve/Audit Performance Claim, Maintain Participant Demographics, Inquire Participant Performance, Inquire Participant Objectives, Inquire Participant Awards Issued, Submit Single Participant Enrollment, Submit Participant Enrollment Batch, Submit Participant Objectives Batch, Submit Single Participant Performance, Search Participants Issue Discretionary Awards and/or Audit Participant Activity.

78. The system of claim 75 wherein the participant interface permits the participant to perform one or more of the following with regard to accessing the programs: View Gateway, View Program Homepage, View Program FAQs, View Program Rules, View/Submit Contact Us email, View Organization; Select & View Reports, Recognize Someone, View Award Account Statement, View Recognition Programs, and/or Submit Performance Claim.

79. The system of claim 75 including three distinct web sites, one for implementing each of the administrative interface, the operational interface and the participant interface.

80. The system of claim 75 wherein the participant interface is linked to other award sites for fulfilling participant awards.

81. A method for use with a resource of programs comprising:
providing access to the resource of programs;
permitting an administrator to maintain the programs via the platform;
permitting each participant of the particular program to access the particular program via the platform, and
permitting each participant site administrator to maintain and administer the program.
